(19) United States
(12) Patent Application Publication
(10) Pub. No.: US 2022/0220726 A1
(43) Pub. Date: Jul. 14, 2022

(54) Wall Component Appurtenances

(71) Applicant: Build IP LLC, North Las Vegas, NV (US)

(72) Inventors: Paolo Tiramani, Las Vegas, NV (US); Galiano Tiramani, Las Vegas, NV (US); Kyle Denman, North Las Vegas, NV (US)

(21) Appl. No.: 17/587,051

(22) Filed: Jan. 28, 2022

Related U.S. Application Data
(63) Continuation-in-part of application No. PCT/US2021/056415, filed on Oct. 25, 2021.
Application No. PCT/US2021/056415 is a continuation-in-part of application No. 17/504,883, filed on Oct. 19, 2021.
(60) Provisional application No. 63/196,400, filed on Jun. 3, 2021.
(60) Provisional application No. 63/181,447, filed on Apr. 29, 2021.
(60) Provisional application No. 63/136,268, filed on Jan. 12, 2021.
(60) Provisional application No. 63/196,400, filed on Jun. 3, 2021.
(60) Provisional application No. 63/181,447, filed on Apr. 29, 2021.
(60) Provisional application No. 63/136,268, filed on Jan. 12, 2021.
(60) Provisional application No. 63/211,712, filed on Jun. 17, 2021.
(60) Provisional application No. 63/196,400, filed on Jun. 3, 2021.
(60) Provisional application No. 63/192,349, filed on May 24, 2021.
(60) Provisional application No. 63/181,447, filed on Apr. 29, 2021.
(60) Provisional application No. 63/188,101, filed on May 13, 2021.

(51) Int. Cl. E04B 1/41; E04B 1/344; E04C 2/292; E04B 2/00; E04F 19/04

(52) U.S. Cl. CPC E04B 1/40; E04B 1/3445; E04B 2001/34389; E04C 2/46; E04F 19/0468; E04C 2/292

(57) ABSTRACT

A toe screw housing, for securing abutting enclosure components together, having a bearing plate with an interior face, an exterior face and a beveled upper edge; a toe screw well joined to and extending away from the interior face and including a fastener shelf; a toe screw support joined to the interior face, and additionally joined to and extending away from the fastener shelf, the toe screw support distal from the fastener shelf including a planar support surface oriented perpendicular to the interior face; and a fastener bore passing through the fastener shelf, the toe screw support and the support surface and inclined at a second angle relative to the interior face of the bearing plate.

### CROSS-REFERENCES TO RELATED APPLICATION

This application is a continuation in part application of PCT Patent Application No. PCT/US21/56415, filed Oct. 25, 2021, which claims the benefit of U.S. Provisional Application Nos. 63/196,400, filed Jun. 3, 2021; 63/181,447, filed Apr. 29, 2021; and 63/136,268, filed Jan. 12, 2021; and a continuation in part application of U.S. Nonprovisional application Ser. No. 17/504,883, filed Oct. 19, 2021; which claims the benefit of U.S. Provisional Application Nos. 63/196,400, filed Jun. 3, 2021; 63/181,447, filed Apr. 29, 2021; and 63/136,268, filed Jan. 12, 2021; and this application claims the benefit of U.S. Provisional Application Nos. 63/211,712, filed Jun. 17, 2021; 63/196,400, filed Jun. 3, 2021; 63/188,101, filed May 13, 2021; 63/192,349, filed May 24, 2021; and 63/181,447, filed Apr. 29, 2021.

### BACKGROUND OF THE INVENTION

### Field of the Invention

The inventions herein relate to structures, such as dwellings and other buildings for residential occupancy, commercial occupancy and/or material storage, and to components for such structures.

### Description of the Related Art

In the field of residential housing, the traditional technique for building homes is referred to as “stick-built” construction, where a builder constructs housing at the intended location using in substantial part raw materials such as wooden boards, plywood panels, and steel columns. The materials are assembled piece by piece over a previously prepared portion of ground, for example, a poured concrete slab or a poured concrete or cinder block foundation.

There have been a variety of efforts to depart from the conventional construction techniques used to create dwellings, as well as commercial spaces and like, in an effort to reduce costs. In this regard, significant advancements in the construction of dwellings and commercial space have been made by the current inventors, as exemplified by their patent documents, including U.S. Pat. Nos. 8,474,194, 8,733,029, 10,688,906, 10,829,029, 10,926,689 and 11,220,816. In one aspect, these patents pertain to fabricating wall, floor and roof components in a factory that are folded together into a compact shipping module, and which are then transported to the intended location and unfolded to yield a fully formed structure.

### SUMMARY OF THE INVENTION

The present inventions describe advancements in the design of appurtenances for building structures, particularly for the wall components of such structures.

In a first aspect, the present inventions are directed to a toe screw housing for securing abutting enclosure components together. The toe screw housing comprises a bearing plate with a planar interior face, a planar exterior face and a beveled upper edge beveled at a non-perpendicular first angle relative to the exterior face. There is provided a toe screw well, joined to and extending away from the interior face of the bearing plate, which includes a fastener shelf, and there is provided a toe screw support that is joined to the interior face of the toe screw housing, and which is also joined to and extending away from the fastener shelf. The toe screw support distal from the fastener shelf includes a planar support surface oriented perpendicular to the interior face. A fastener bore passes through the fastener shelf, the toe screw support and the support surface, and is inclined at a non-perpendicular second angle relative to the interior face of the bearing plate.

In a second aspect, the present inventions are directed to a baseboard for masking a toe screw bearing plate that has a beveled upper edge. The baseboard comprises a planar elongate member having an elongate interior face, an elongate top edge and an elongate bottom edge. An elongate hook ledge is joined to the top edge of the base board to form a wedge-shaped angled slot that is oriented to be open in the direction of the bottom edge, with the wedge-shaped angled slot configured to be positioned over the beveled upper edge of the bearing plate. There is provided an elongate linear first step positioned on the interior face below the angled slot to form an elongate first recess on the interior face configured to receive the toe screw bearing plate, and there is provided an elongate second step positioned on the interior face below the elongate first step to form an elongate second recess on the interior face.

These and other aspects of the present inventions are described in the drawings annexed hereto, and in the description of the preferred embodiments and claims set forth below.

### BRIEF DESCRIPTION OF THE DRAWINGS

FIG. 1 is a perspective view of a structure prepared in accordance with the present inventions.

FIG. 2 is a top schematic view of the structure shown in FIG. 1.

FIG. 3 is an end view of a shipping module from which is formed the structure shown in FIG. 1.

FIGS. 4 and 5 are partial cutaway views of a structure in accordance with the present inventions, depicting in greater detail aspects of the roof, wall and floor components.

FIG. 6 is a schematic perspective view depicting the exterior edge reinforcement for a wall component in accordance with the present inventions.

FIG. 7 is an exploded cross-sectional view of a multi-layered, laminate design for use in the enclosure components of the present inventions.

FIG. 8A is a front perspective view of a toe screw housing in accordance with the present inventions, FIG. 8B is a rear perspective view (looking upward) of a toe screw housing in accordance with the present inventions, and FIG. 8C is a side view of a toe screw housing in accordance with the present inventions.

FIGS. 9A, 9B and 9C are respectively front perspective, rear perspective and side views of an interior baseboard in accordance with the present inventions.

FIG. 10A is a side section view depicting a toe screw housing and an interior baseboard portion for a wall component in accordance with the present inventions, FIG. 10B is a side section view depicting a junction between a wall portion and a floor portion secured by a fastener inserted through a toe screw housing, and FIG. 10C is a perspective cutaway view of representative placements of toe screw housings in accordance with the present inventions.

FIGS. 11A, 11B and 11C are respectively perspective, top and side cutaway views of a fixed space portion of a structure in accordance with the present inventions.

### DETAILED DESCRIPTION OF THE PREFERRED EMBODIMENTS

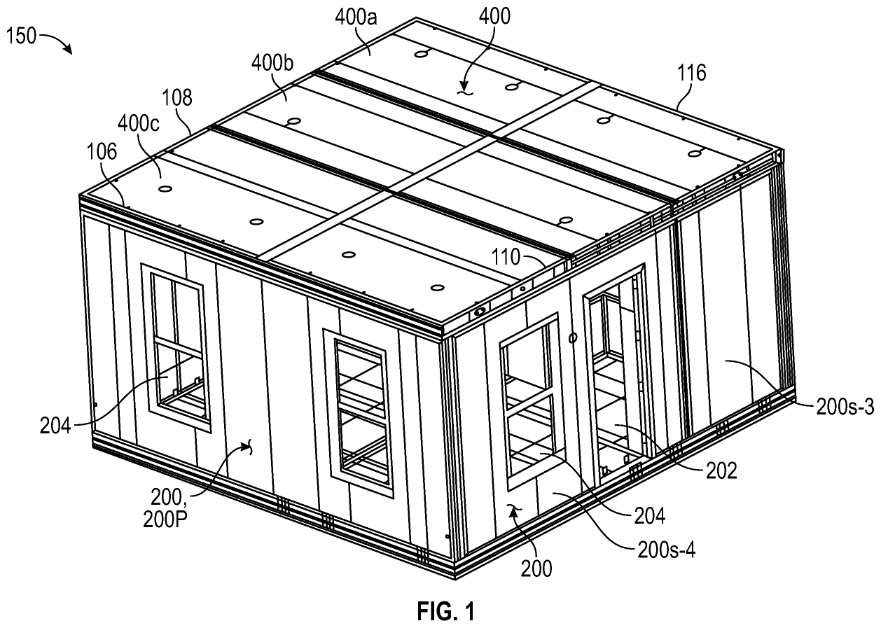

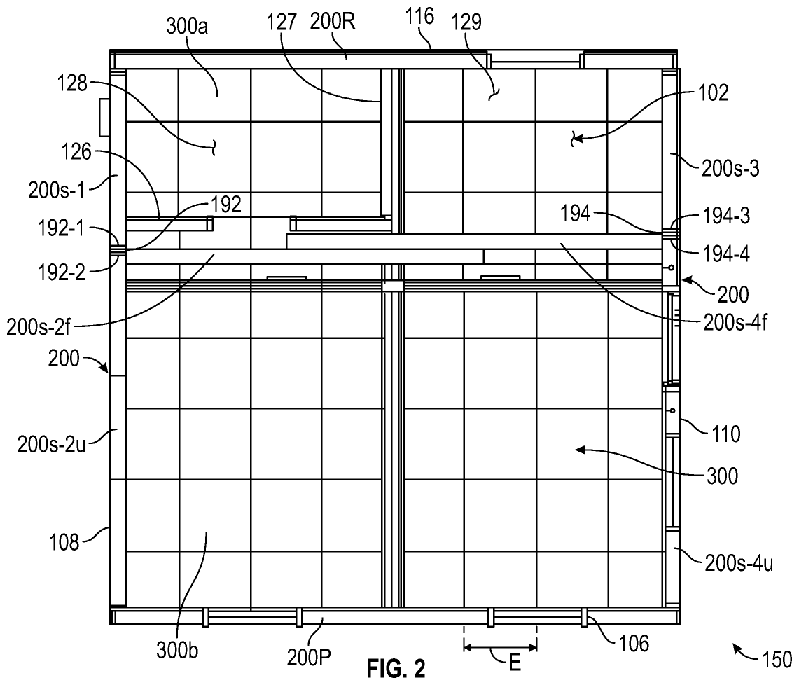

An embodiment of the foldable, transportable structure 150 in which the inventions disclosed herein can be implemented is depicted in FIGS. 1 through 5. When fully unfolded, as exemplified by FIG. 1, structure 150 has a rectangular shape made of three types of generally planar and rectangular enclosure components 155, the three types of enclosure components 155 consisting of a wall component 200, a floor component 300, and a roof component 400. As shown in FIGS. 1 and 2, the perimeter of structure 150 is defined by first longitudinal edge 106, first transverse edge 108, second longitudinal edge 116 and second transverse edge 110. For convenience, a direction parallel to first longitudinal edge 106 and second longitudinal edge 116 may be referred to as the “longitudinal” direction, a direction parallel to first transverse edge 108 and second transverse edge 110 may be referred to as the “transverse” direction; and a direction parallel to the vertical direction in FIG. 1 may be referred to as the “vertical” direction. Structure 150 as shown has one floor component 300, one roof component 400 and four wall components 200; although it should be understood that the present inventions are applicable to structures having other configurations as well.

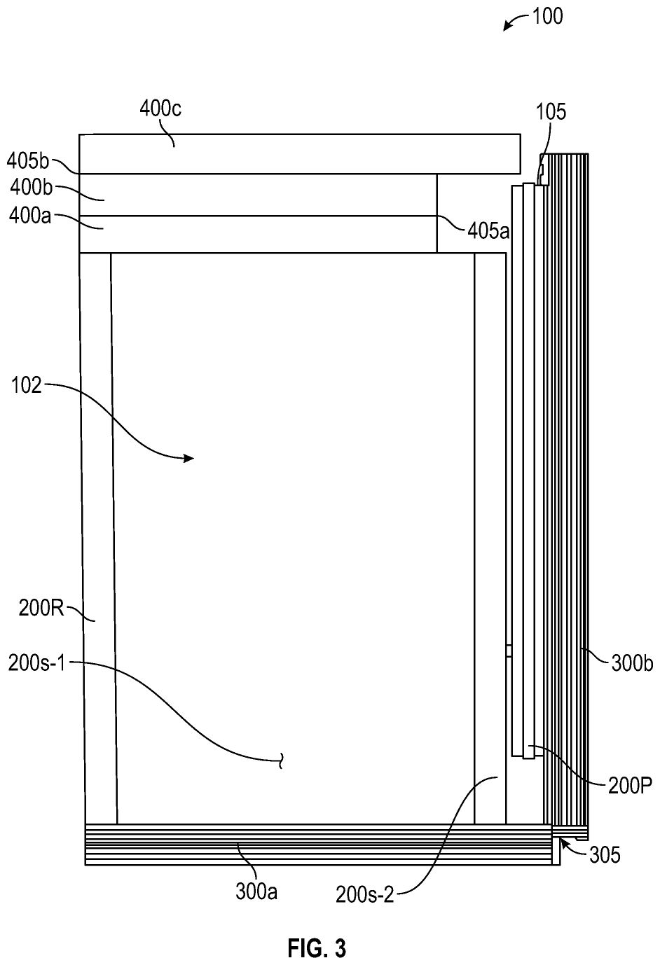

Enclosure components 155 (wall component 200, floor component 300 and roof component 400) can be fabricated and dimensioned as described herein and positioned together to form a shipping module 100, shown end-on in FIG. 3. The enclosure components 155 are dimensioned so that the shipping module 100 is within U.S. federal highway dimensional restrictions. As a result, shipping module 100 can be transported over a limited access highway more easily, and with appropriate trailering equipment, transported without the need for oversize permits. Thus, the basic components of structure 150 can be manufactured in a factory, positioned together to form the shipping module 100, and the modules 100 can be transported to the desired site for the structure, where they can be readily assembled, as described herein.

### Enclosure Component (155): General Description

The enclosure components 155 of the present invention include a number of shared design features that are described below.

### A. Laminate Structure Design

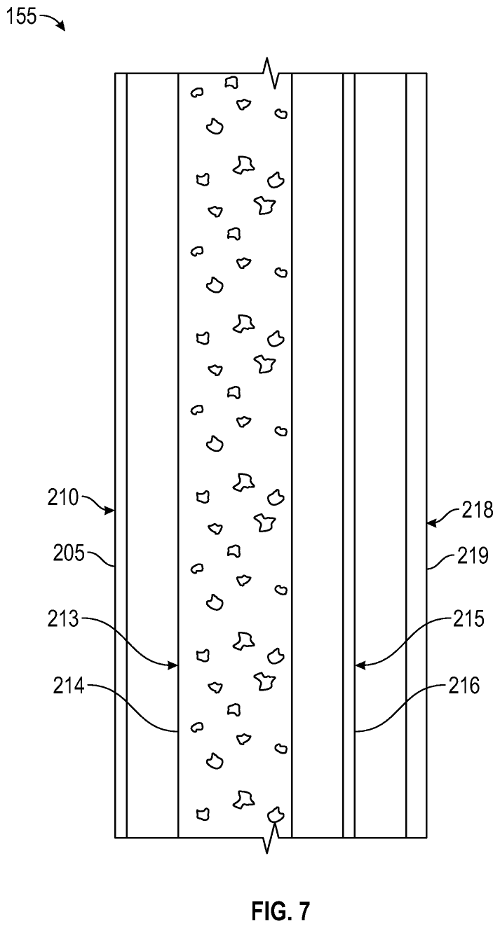

Enclosure components 155 can be fabricated using a multi-layered, laminate design. A particular laminate design that can be used to fabricate enclosure components 155 comprises a first structural layer 210, a foam panel layer 213, a second structural layer 215 and a protective layer 218, as shown in FIG. 7 and described further below.

In particular, first structural layer 210 is provided in the embodiment of enclosure component 155 that is depicted in FIG. 7. First structural layer 210 in the embodiment shown comprises a sheet metal layer 205, which can be for example galvanized steel or aluminum. Sheet metal layer 205 is made from a plurality of generally planar rectangular metal sheets 206 positioned adjacent to each other to generally cover the full area of the intended enclosure component 155.

Referring again to FIG. 7, there is next provided in the depicted embodiment of enclosure component 155 a foam panel layer 213, comprising a plurality of generally planar rectangular foam panels 214 collectively presenting a first face 211 and a second opposing face 212. Foam panels 214 are made for example of expanded polystyrene (EPS) foam. A number of these foam panels 214 are positioned adjacent to each other and superposed first face-down on first structural layer 210 to generally cover the full area of the intended enclosure component 155. The foam panels 214 of foam panel layer 213 preferably are fastened to first structural layer 210 using a suitable adhesive, preferably a polyurethane based construction adhesive.

In the embodiment of the enclosure component 155 depicted in FIG. 7, there is next provided a second structural layer 215, having a first face that is positioned on the second opposing face 212 of foam panels 214 (the face distal from first structural layer 210), and also having a second opposing face. Second structural layer 215 in the embodiment shown comprises a sheet metal layer 216, which can be for example galvanized steel or aluminum. Sheet metal layer 216 is made from a plurality of generally planar rectangular metal sheets 217 positioned adjacent to each other and superposed first face-down on the second opposing face of foam panel layer 213 to generally cover the full area of the intended enclosure component 155. The metal sheets 217 of second structural layer 215 preferably are fastened to foam panel layer 213 using a suitable adhesive, preferably a polyurethane based construction adhesive.

In the embodiment of the enclosure component 155 depicted in FIG. 7, there is optionally next provided a protective layer 218, having a first face that is positioned on the second opposing face of second structural layer 215 (the face distal from foam panel layer 213), and also having a second opposing face. Optional protective layer 218 in the embodiment shown comprises a plurality of rectangular structural building panels 219 principally comprising an inorganic composition of relatively high strength, such as magnesium oxide (MgO). The structural building panels 219 are positioned adjacent to each other and superposed first face-down on the second opposing face of second structural layer 215 to generally cover the full area of the intended enclosure component 155. The building panels 219 of protective layer 218 preferably are fastened to second structural layer 215 using a suitable adhesive, preferably a polyurethane based construction adhesive. Protective layer 218 can be used if desired to impart a degree of fire resistance to the enclosure component 155, as well as to provide a pleasing texture and/or feel.

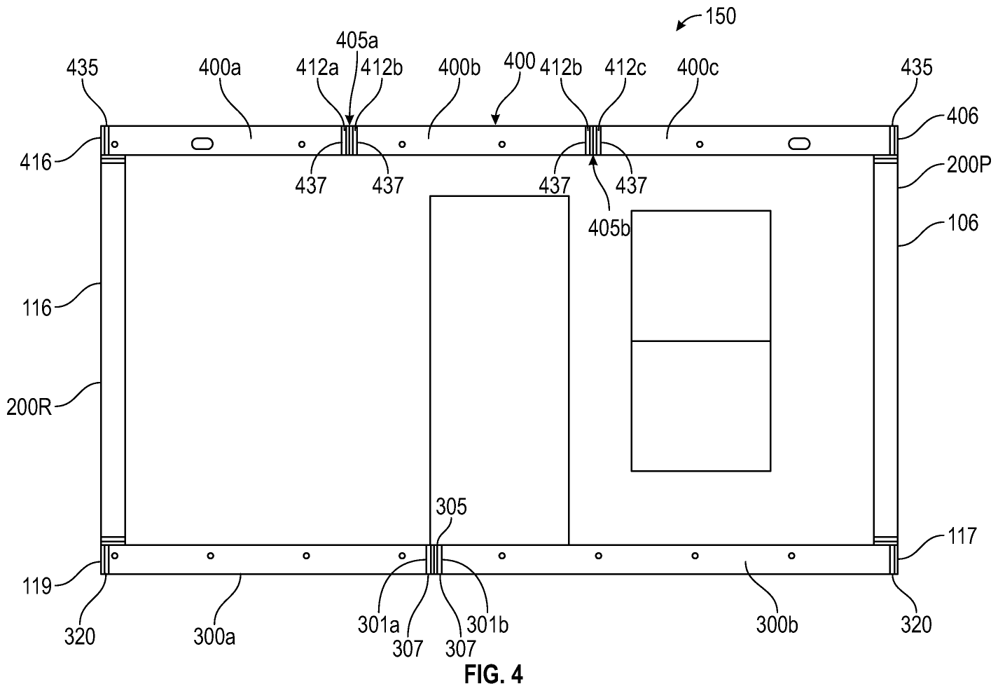

Other embodiments of multi-layered, laminate designs that can be used to fabricate the enclosure components 155 of the present invention, are described in U.S. Nonprovisional patent application Ser. No. 16/786,130, entitled “Foldable Building Structures with Utility Channels and Laminate Enclosures,” filed on Feb. 10, 2020 and now issued as U.S. Pat. No. 11,118,344. The contents of that U.S. Nonprovisional patent application Ser. No. 16/786,130, entitled “Foldable Building Structures with Utility Channels and Laminate Enclosures” and filed on Feb. 10, 2020 are incorporated by reference as if fully set forth herein, particularly including the multi-layered, laminate designs described for example at [symbol] 0034-57 and depicted in FIGS. 4A-4D thereof.

### B. Enclosure Component Exterior Edge Reinforcement

The exterior edges of each enclosure component 155 (i.e., the edges that define the perimeter of enclosure component 155) can be provided with exterior edge reinforcement, as desired. Exterior edge reinforcement generally comprises an elongate, rigid member which can protect foam panel material that would otherwise be exposed at the exterior edges of enclosure components 155. Exterior edge reinforcement can be fabricated from one or more of laminated strand lumber board, wooden board, C-channel extruded aluminum or steel, or the like, and is generally secured to the exterior edges of enclosure component 155 with fasteners, such as screw or nail fasteners, and/or adhesive.

### C. Enclosure Component Partitioning

Enclosure components 155 in certain instances are partitioned into enclosure component portions to facilitate forming a compact shipping module 100. In those instances where an enclosure component 155 is partitioned into enclosure component portions, any exterior edge reinforcement on the exterior edges defining the perimeter of the enclosure component is segmented as necessary between or among the portions.

The enclosure component portions can be joined by hinge structures or mechanisms to permit the enclosure component portions to be “folded” and thereby contribute to forming a compact shipping module 100.

### D. Enclosure Component Interior Edge Reinforcement

An enclosure component 155 partitioned into enclosure component portions will have interior edges. There will be two adjacent interior edges for each adjacent pair of enclosure component portions. Such interior edges can be provided with interior edge reinforcement. Similar to exterior edge reinforcement, such interior edge reinforcement generally comprises an elongate, rigid member which can protect foam panel material that would otherwise be exposed at the interior edges of enclosure components 155. Interior edge reinforcement can be fabricated from one or more of laminated strand lumber board, wooden board, C-channel extruded aluminum or steel, or the like, and is generally secured to the interior edges of enclosure component 155 with fasteners, such as screw or nail fasteners, and/or adhesive.

### E. Enclosure Component Load Transfer

In the case of enclosure components 155, it is necessary to transfer the loads imposed on their surfaces to their exterior edges, where those loads can be transferred either to or through adjoining walls, or to the building foundation. For enclosure components 155 that are horizontally oriented when in use (floor component 300 and roof component 400), such loads include the weight of equipment, furniture and people borne by their surfaces, as well as vertical seismic loads. For enclosure components that are vertically oriented when in use (wall component 200), such loads include those arising from meteorological conditions (hurricanes, tornadoes, etc.) and human action (vehicle and other object impacts).

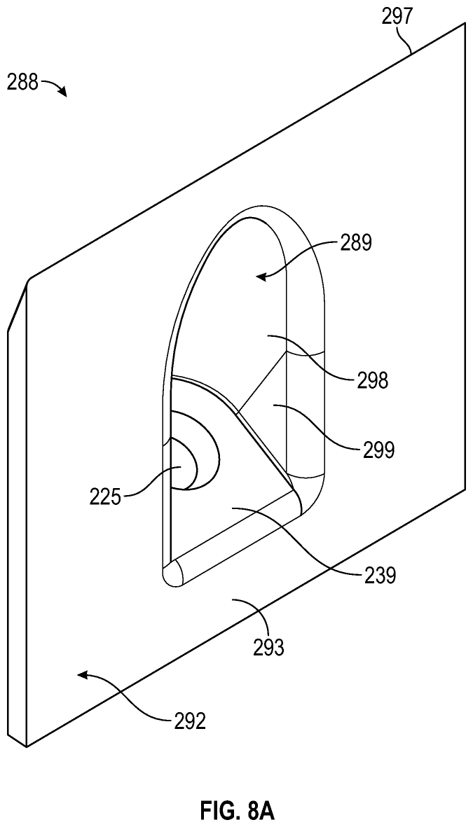

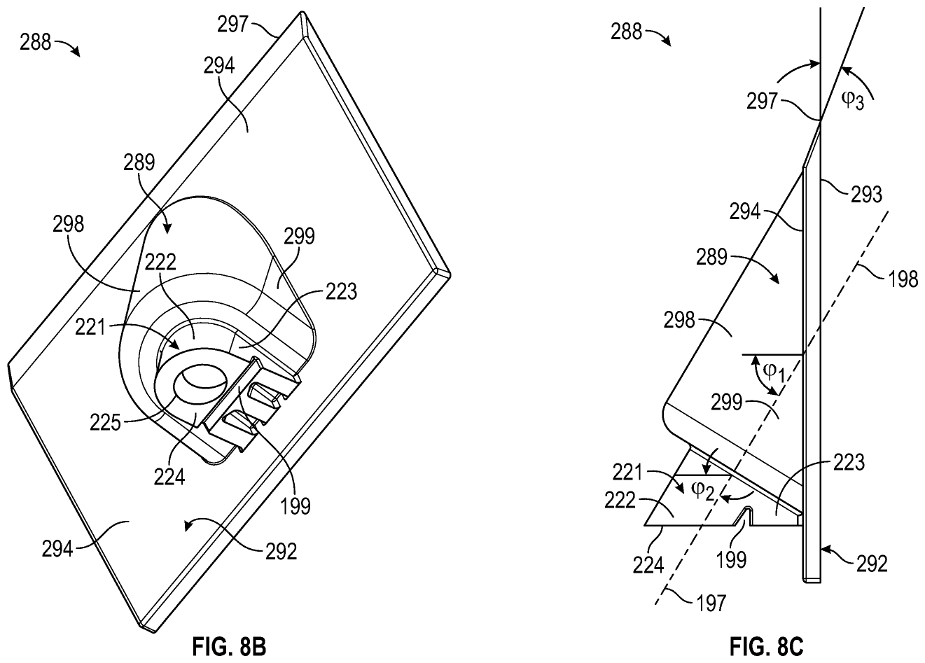

For this purpose, multi-layered, laminate designs as shown in FIG. 7 will function to transfer the loads described above. To add additional load transfer capability, structural members, such as beams and/or joists, can be utilized within the perimeter of the enclosure components 155, as is deemed appropriate to the specific design of structure 150 and the particular enclosure component 155, to assist in the transfer of loads to the exterior edges. Particular embodiments of such structural members, which also incorporate hinge structures, are described in U.S. Nonprovisional patent application Ser. No. 17/527,520 entitled “Folding Beam Systems”, filed Nov. 16, 2021 and having the same inventors as this disclosure. The contents of that U.S. Nonprovisional patent application Ser. No. 17/527,520 entitled “Folding Beam Systems”, filed Nov. 16, 2021 and having the same inventors as this disclosure, is incorporated by reference as if fully set forth herein, particularly the description of the hinged load transfer components set forth for example in [symbol] 0074-0089 and 0104-0126 and in FIGS. 8A-13E and 15A-24A thereof, as well as the description of the associated end hinge assemblies set forth for example in [symbol] 0090-0093 and 0127-0132 and in FIGS. 14A-14B, 24B and 25A-25D thereof.

### F. Enclosure Component Sealing Systems

Structure 150 comprises a number of wall, floor and roof components with abutting or exposed exterior edges, as well as a number of partitioned wall, floor and roof components with interior edges. In this regard, sealing structures can be utilized, with the objective to limit or prevent the ingress of rain water, noise and outside air across these exterior and interior edges into the interior of structure 150.

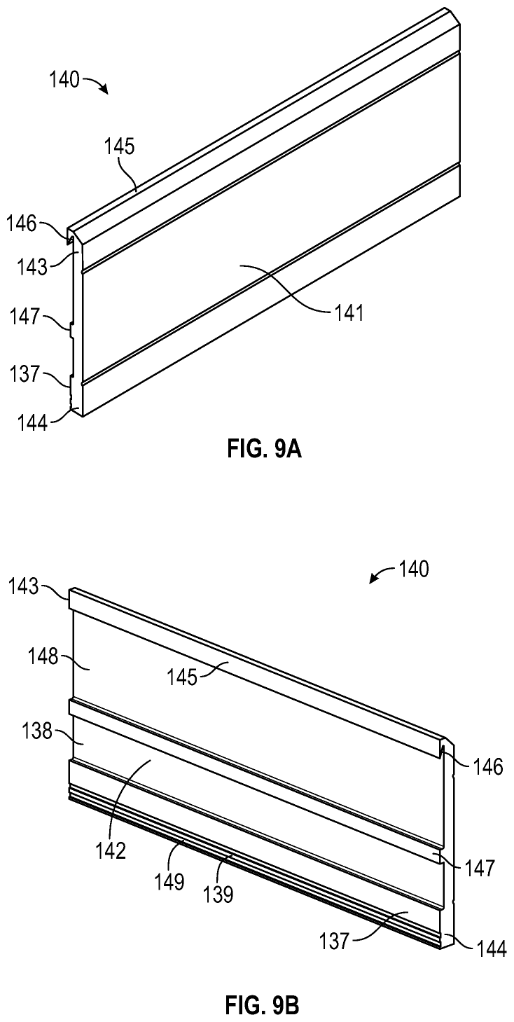

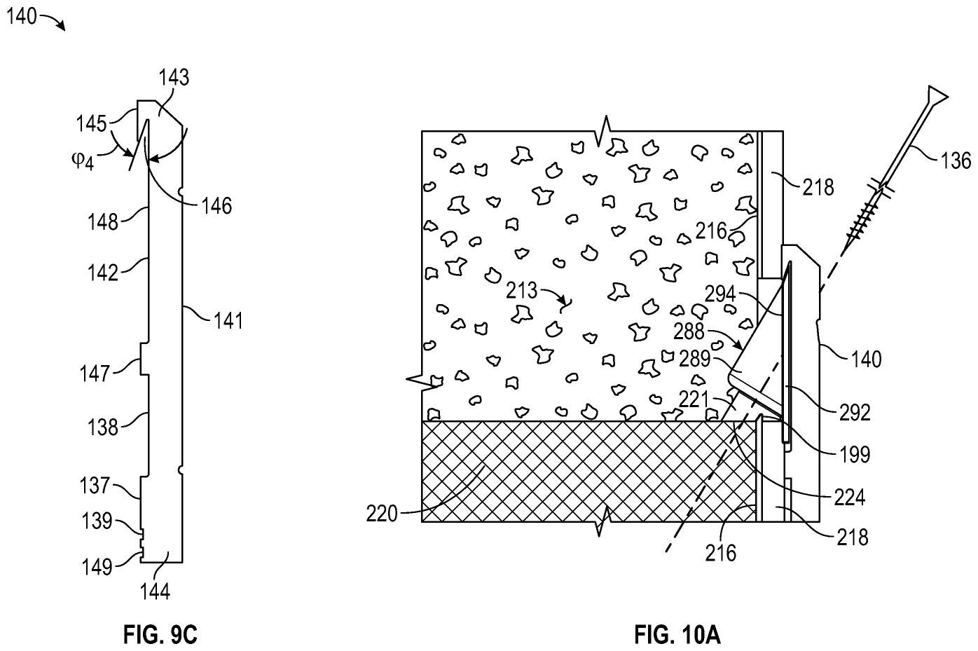

Particular sealing structures for accomplishing the foregoing objective are described in PCT Patent Application No. PCT/US21/56415, entitled “Enclosure Component Sealing Systems,” filed on Oct. 25, 2021 and having the same inventors as the present application. The contents of that PCT Patent Application No. PCT/US21/56415, entitled “Enclosure Component Sealing Systems,” filed on Oct. 25, 2021 and having the same inventors as this disclosure, are incorporated by reference as if fully set forth herein, particularly including the sealing systems described for example at [symbol] 0080-0167 and depicted in FIGS. 9-20 thereof, and also including the exemplary placements for such sealing systems described in [symbol] 0168-0174 and depicted in FIGS. 8A-8B thereof.

Further design details of wall component 200, floor component 300, and roof component 400 are provided in the sections following.

### Wall Component (200)

Typically, structure 150 will utilize four wall components 200, with each wall component 200 corresponding to an entire wall of structure 150.

### A. General Description

Wall component 200 has a generally rectangular perimeter. As shown in FIG. 1, wall components 200 have plural apertures, specifically a door aperture 202, which has a door frame and door assembly, and plural window apertures 204, each of which has a window frame and a window assembly. The height and length of wall components 200 can vary in accordance with design preference, subject as desired to the dimensional restrictions applicable to transport, described above. In this disclosure, structure 150 is fashioned with all sides of equal length; accordingly, its first and second longitudinal edges 106 and 116, and its first and second transverse edges 108 and 110, are all of equal length. It should be understood however, that the inventions described herein are applicable to structures having other dimensions, such as where two opposing wall components 200 are longer than the other two opposing wall components 200.

As indicated above, wall components 200 of the present inventions can utilize a multi-layered, laminate design. In the embodiment depicted in FIGS. 1 through 6, wall component 200 utilizes the multi-layered, laminate design shown in FIG. 7 employing these particular elements: sheet metal layer 205 of first structural layer 210 is 24 gauge galvanized steel approximately 0.022-0.028 inch thick, the foam panels 214 of foam panel layer 213 are EPS foam approximately 5.68 inches thick, the sheet metal layer 216 of second structural layer 215 is 24 gauge galvanized steel approximately 0.022-0.028 inch thick, and the building panels 219 of protective layer 218 are MgO board approximately 0.25 inch (6 mm) thick.

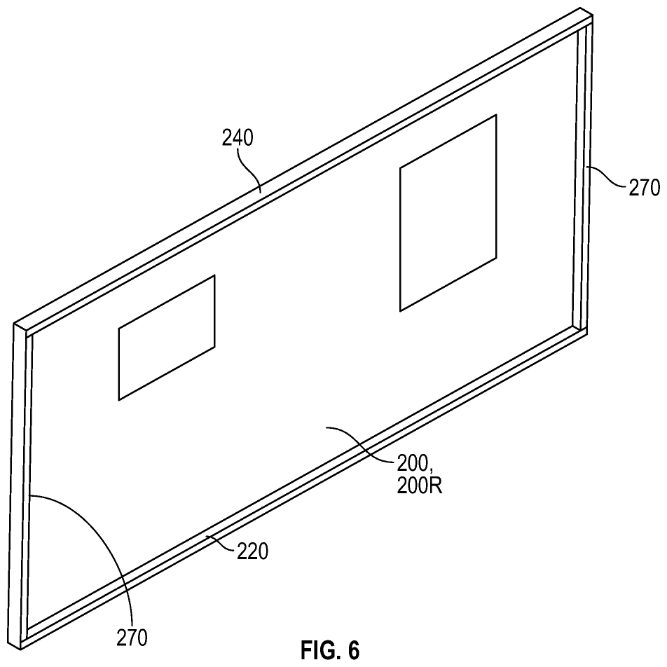

The perimeter of each wall component 200 is generally provided with exterior edge reinforcement. As exemplified by wall component 200 shown in FIG. 6, the exterior edge reinforcement for wall component 200 is a floor plate 220 along the bottom horizontal edge, a ceiling plate 240 along the top horizontal edge and two end pieces 270 respectively fastened at each vertical edge of wall component 200. In the case of a wall component 200, exterior edge reinforcement provides regions for fastening like regions of abutting wall components 200, roof component 400 and floor component 300, in addition to protecting the exterior edges of foam panel material. In the embodiment shown in FIGS. 1 through 6, the exterior edge reinforcement for wall component 200 provided by floor plate 220, ceiling plate 240, and end pieces 270 is fabricated from laminated strand lumber board 5.625″ deep and 1.5″ thick.

### B. Partitioned Wall Components

Referring to FIG. 2, structure 150 has two opposing wall components 200, where one of the two opposing wall components 200 comprises first wall portion 200s-1 and second wall portion 200s-2, and the other of the two opposing wall components 200 comprises third wall portion 200s-3 and fourth wall portion 200s-4. Each of wall portions 200s-1, 200s-2, 200s-3 and 200s-4 has a generally rectangular planar structure. As shown in FIG. 2, the interior vertical edge 192-1 of wall portion 200s-1 is proximate to a respective interior vertical edge 192-2 of wall portion 200s-2, and the interior vertical edge 194-3 of wall portion 200s-3 is proximate a respective interior vertical wall edge 194-4 of wall portion 200s-4. Interior edge reinforcement can be provided at any one or more of vertical edges 192-1, 192-2, 194-3 and 194-4. In the embodiment shown in FIGS. 1 through 6, the interior edge reinforcement provided at vertical edges 192-1, 192-2, 194-3 and 194-4 is fabricated from laminated strand lumber board 5.625″ deep and 1.5″ thick.

Referring again to FIG. 2, first wall portion 200s-1 is fixed in position on floor portion 300a proximate to first transverse edge 108, and third wall portion 200s-3 is fixed in position on floor portion 300a, opposite first wall portion 200s-1 and proximate to second transverse edge 110. First wall portion 200s-1 is joined to second wall portion 200s-2 with a hinge structure that permits wall portion 200s-2 to pivot about vertical axis 192 between a folded position and an unfolded position, and third wall portion 200s-3 is joined to fourth wall portion 200s-4 with a hinge structure to permit fourth wall portion 200s-4 to pivot about vertical axis 194 between a folded position and an unfolded position.

Notably, first wall portion 200s-1 is longer than third wall portion 200s-3 by a distance approximately equal to the thickness of wall component 200, and second wall portion 200s-2 is shorter than fourth wall portion 200s-4 by a distance approximately equal to the thickness of wall component 200. Furthermore, wall portion 200s-1 and wall portion 200s-3 are each shorter in length (the dimension in the transverse direction) than the dimension of floor portion 300a in the transverse direction. Dimensioning the lengths of wall portions 200s-1, 200s-2, 200s-3 and 200s-4 in this manner permits wall portions 200s-2 and 200s-4 to nest against each other in an overlapping relationship when in an inwardly folded position. In this regard, FIG. 2 depicts wall portions 200s-2 and 200s-4 both in their unfolded positions, where they are labelled 200s-2u and 200s4-u respectively, and FIG. 2 also depicts wall portions 200s-2 and 200s-4 both in their inwardly folded positions, where they are labelled 200s-2f and 200s4-f respectively. When wall portions 200s-2 and 200s-4 are in their inwardly folded positions (200s-2f and 200s-4f), they facilitate forming a compact shipping module. When wall portion 200s-2 is in its unfolded position (200s-2u), it forms with wall portion 200s-1 a wall component 200 proximate first transverse edge 108, and when wall portion 200s-4 is in its unfolded position (200s-4u), it forms with wall portion 200s-3 a wall component 200 proximate second transverse edge 110.

The hinge structures referenced for securing first wall portion 200s-1 to second wall portion 200s-2, and third wall portion 200s-3 to fourth wall portion 200s-4, can be surface mounted or recessed, and of a temporary or permanent nature. The provision of interior edge reinforcement, as described above, can provide a region for securing hinge structures. Suitable hinge structures can be fabricated for example of ferrous or non-ferrous metal, plastic or leather material.

### C. Unpartitioned Wall Components

As compared to the two wall components 200 proximate first and second transverse edges 108 and 110, which are partitioned into wall portions, the remaining two wall components 200 proximate first and second longitudinal edges 106 and 116 do not comprise plural wall portions, but rather each is a single piece structure. However, one of these wall components 200, which is sometimes denominated 200P in this disclosure, and which is located on floor portion 300b proximate first longitudinal edge 106, is pivotally secured to floor portion 300b to permit wall component 200P to pivot about horizontal axis 105 shown in FIG. 3 from a folded position to an unfolded position. Pivotally securing wall component 200P also facilitates forming a compact shipping module 100. The remaining wall component 200, sometimes denominated 200R in this disclosure, is rigidly secured on floor portion 300a proximate second longitudinal edge 116 and abutting the vertical edges of first wall portion 200s-1 and third wall portion 200s-3 proximate to second longitudinal edge 116, as shown in FIG. 2.

The hinge structures described above, for securing wall component 200P to floor portion 300b, can be surface mounted or recessed, and of a temporary or permanent nature. The provision of exterior edge reinforcement, as described above, can provide a region for securing hinge structures. Suitable hinge structures can be fabricated for example of metal, plastic, leather, ferrous or non-ferrous material.

### D. Wall Component Appurtenances

Certain appurtenances can be fitted to wall components 200 to facilitate fastening them to floor component 300 (described below), as well as to improve the interior appearance and speed fabrication.

As a first appurtenance that can be fitted to wall components 200, FIGS. 8A-8C depict a toe screw housing 288, whose principal components comprise a bearing plate 292, a toe screw well 289 and a toe screw support 221. Bearing plate 292 is a planar plate of a select thickness having a rectangular perimeter, and includes an exterior face 293, an opposed interior face 294 and a top, bevel edge 297. Toe screw well 289 comprises a semi-cylindrical wall 298 having an axial centerline 198, shown in FIG. 8C, which is oriented at an angle (pi from a line normal to the interior face 294 of bearing plate 292. Angle φ₁ can be in the range of forty-five) (45°) to seventy (70°) degrees, such as sixty (60°) degrees. The exterior face 293 of bearing plate 292 defines an aperture that renders the interior volume of toe screw well 289 accessible from the exterior face side of toe screw well 289.

An upper portion of semi-cylindrical wall 298 is angularly sectioned, for example at an angle of ninety degrees (90°) minus φ₁, relative to axial centerline 198, for example in the range of forty-five (45°) to twenty (20°) degrees, such as thirty (30°) degrees, with the upper portion so sectioned joined to interior face 294. A lower portion of semi-cylindrical wall 298 is further sectioned parallel to axial centerline 198, with each of the resultant two axially-oriented edges joined to a respective triangular gusset 299. The two gussets 229 are spatially opposed and joined to the interior face 294 of bearing plate 292. Toe screw well 289 also includes a fastener shelf 239, visible in FIG. 8A, which is joined to semi-cylindrical wall 298 and each of the two gussets 299. The interior volume of toe screw well 289, which is defined by fastener shelf 239, gussets 299 and semi-cylindrical wall 298, forms a recess within toe screw well 289 for receiving a fastener head. Fastener shelf 239 has a planar upper face that is perpendicularly oriented to the axial centerline 198 of semi-cylindrical surface 298, and a planar opposed lower face that is perpendicularly oriented to the axial centerline 198 of semi-cylindrical surface 298. It should be noted that the upper face of fastener shelf 239 will correspondingly be oriented at angle (pi relative to interior face 294 and exterior face 293.

The lower face of fastener shelf 239 is joined to a toe screw support 221. Toe screw support 221 comprises a semi-cylindrical solid 222 and a triangular wedge 223. Semi-cylindrical solid 222 has an axial centerline 197, shown in FIG. 8C, which is oriented at an angle φ₂ from a line normal to the interior face 294 of bearing plate 292. Angle φ₂ can be in the range of forty-five (45°) to seventy (70°) degrees, such as sixty (60°) degrees, and preferably φ₁ equals φ₂. Centerlines 197 and 198 can be, but need not be, co-linear. The upper portion of semi-cylindrical solid 222 is sectioned normal to axial centerline 197, with the sectioned portion joined to the lower face of fastener shelf 239, and is further sectioned parallel to axial centerline 197 and joined to triangular wedge 223. In turn, the upper surface of wedge 223 is joined to the lower face of fastener shelf 239, and wedge 223 is further joined at its narrow end to the interior face 294 of bearing plate 292. The diameter of semi-cylindrical solid 222 is less than the diameter of semi-cylindrical wall 298, in the embodiment shown in FIGS. 8A-8C.

Toe screw support 221 also includes a support surface 224 defined by the lower surfaces of semi-cylindrical solid 222 and wedge 223. Support surface 224 is perpendicularly oriented to the interior face 294 of bearing plate 292. A groove 199 is cut into the planar lower surface of support surface 224. Groove 199 is oriented parallel to the interior face 294 of bearing plate 292, and, in the embodiment shown in the figures, is spaced from interior face 294 a distance approximately equal to the thickness of protective layer 218.

A fastener bore 225 passes through fastener shelf 239 and toe screw support 221, with an exit orifice in support surface 224, thereby forming a passage through toe screw support 221 for a fastener, the head of which can be positioned against the upper face of fastener shelf 239. Preferably, the axial centerline of fastener bore 225 is co-linear with the axial centerline 197 of semi-cylindrical wall 222, so that the axial centerline of fastener bore 225 is not perpendicular to the exterior face 293 of bearing plate 292, but rather is oriented at angle φ₂ from a line normal to the exterior face 293 of bearing plate 292.

Bevel edge 297 of toe screw housing 288 forms an angle φ₃ with exterior face 293 to provide a sloped bevel surface between the end of bevel edge 297 and interior face 294 of bearing plate 292. Accordingly, angle φ₃ is not perpendicular to the exterior face 293 of bearing plate 292, but rather is an acute angle, such as forty-five degrees (45°) or less, and in particular twenty degrees (20°).

As a second appurtenance that can be fitted to wall components 200, FIGS. 9A-9C depict an interior baseboard 140. Interior baseboard 140 is a planar elongate member with a planar elongate exterior face 141, a planar elongate interior face 142, an elongate top edge 143 and an elongate bottom edge 144. An elongate hook ledge 145 is joined along the top edge 143 of interior baseboard 140 and forms a downward facing wedge-shaped angled slot 146 that has an interior angle φ₄, shown in FIG. 9C, which is preferably the same as angle φ₃ of bevel edge 297, or nearly so. Interior face 142 has an elongate linear first step 147 positioned below angled slot 146, so as to define an elongate bearing plate recess 148 between angled slot 146 and first step 147 sufficiently wide to receive bearing plate 292. Positioned below first step 147, interior face 142 has an elongate linear second step 137 that extends a distance from bottom edge 144, so as to define a fastening recess 138 between first step 147 and second step 138.

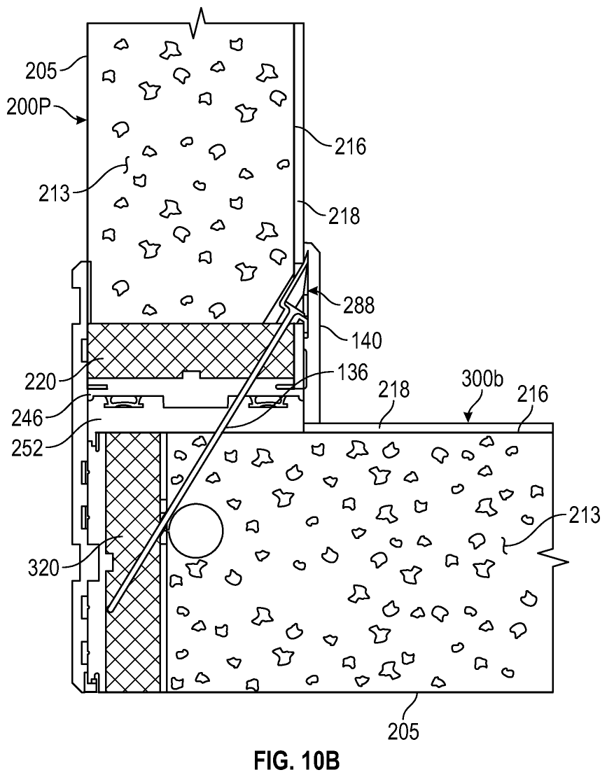

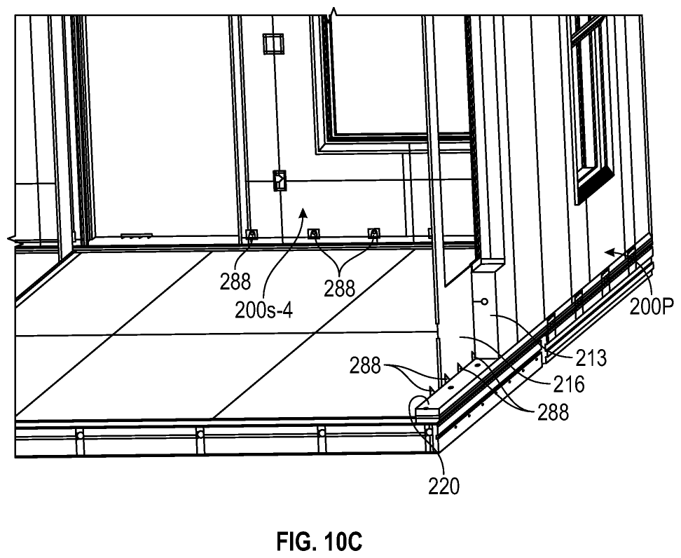

For wall components 200 utilizing the laminate design shown in FIG. 7, a plurality of toe screw housings 288 can be fastened at space-apart intervals in proximity to the bottom of the wall components 200, as shown in FIG. 10C. As shown in FIG. 10A, each toe screw housing 288 is positioned so that the support surface 224 of its toe screw support 221 rests upon the floor plate 220 of the wall component 200. Select portions of the foam panel layer 213, sheet metal layer 216 and protective layer 218 are removed to provide a space to receive the toe screw well 289 and toe screw support 221 of the toe screw housing 288, and so that the interior face 294 of bearing plate 292 of the toe screw housing 288 lies against protective layer 218. As described above, the distance from groove 199 to interior face 294 of bearing plate 292 is approximately equal to the thickness of protective layer 218. When so dimensioned, groove 199 can engage the edge of sheet metal layer 216 immediately below the removed portion thereof, as shown in FIG. 10A.

Plural toe screw housings 288 can be utilized to fasten both partitioned and unpartitioned wall components 200 to floor component 300 (described below). For example, referring to FIGS. 10B and 10C, toe screw housings 288 are shown being utilized in connection with both wall portion 200s-4 and wall component 200P. Following their unfolding (described below), a fastener, such as a SIP screw 136 can be inserted into fastener bore 225, as illustrated in FIG. 10A, and driven into the exterior edge reinforcement of both the wall component 200 and the underlying floor component 300, specifically floor plate 220 and footing beam 320 respectively, as shown in FIG. 10B, to fasten the wall component 200 to the floor component 300.

Plural toe screw housings 288 can also be utilized to fasten each of fixed wall component 200R, fixed wall portion 200s-1, fixed wall portion 200s-3 and pivoting wall portion 200s-2 to floor component 300. In the case of wall component 200R and fixed wall portions 200s-1 and 200s-3, the fastening operation just described can be undertaken during factory fabrication of fixed space portion 102, described further below.

In using toe screw housings 288 to fasten wall component 200P to floor section 300b, it can be seen in FIG. 10B that one or more screws 136 will also pass through two sealing structures, wall end cap 246 and floor top plate 252, which are present at the junction of wall component 200P and floor portion 300b. A similar sealing structure arrangement is present in the cases of the junction between wall component 200R and floor portion 300a, the junction between fixed wall portion 200s-1 and floor portion 300a, and the junction between wall portion 200s-3 and floor component 300a. A more detailed description of these sealing structures is set forth in PCT Patent Application No. PCT/US21/56415, entitled “Enclosure Component Sealing Systems,” filed on Oct. 25, 2021 and having the same inventors as the present application, for example in [symbol] 0092, 0097-0101 and 0112-0120, and in connection with FIGS. 12 and 15, of that application. The contents of that PCT Patent Application No. PCT/US21/56415, entitled “Enclosure Component Sealing Systems,” filed on Oct. 25, 2021 and having the same inventors as this disclosure, are incorporated by reference as if fully set forth herein, particularly including the wall end cap 246 and floor top plate 252 described for example at [symbol] 0092, 0097-0101 and 0112-0120, and in connection with FIGS. 12 and 15, of that application.

In using toe screw housings 288 to fasten wall portions 200s-2 and 200s-4 to floor portions 300a and 300b, one or more screws 136 will also pass through sealing structures that are present at the junction of pivoting wall portion 200s-2 in its unfolded position and floor portions 300a/300b, and at the junction of pivoting wall portion 200s-4 in its unfolded position and floor portions 300a/300b. However, these sealing structures, namely wall end interlock A 262 (not shown) and floor top interlock 261 (not shown), differ from wall end cap 246 and floor top plate 252, in that they are designed to permit the lateral movement of wall portions 200s-2 and 200s-4 relative to floor portions 300a and 300b. A more detailed description of these sealing structures is set forth in PCT Patent Application No. PCT/US21/56415, entitled “Enclosure Component Sealing Systems,” filed on Oct. 25, 2021 and having the same inventors as the present application, for example in [symbol] 0136-0147 and in connection with FIG. 17 thereof. The contents of that PCT Patent Application No. PCT/US21/56415, entitled “Enclosure Component Sealing Systems,” filed on Oct. 25, 2021 and having the same inventors as this disclosure, are incorporated by reference as if fully set forth herein, particularly including the wall end interlock A 262 and floor top interlock 261 described for example at [symbol] 0136-0147 and in connection with FIG. 17 thereof.

After the fasteners are driven into the toe screw housings 288, the housings can be masked from view by placing an interior baseboard 140 of an appropriate length over the toe screw housings, as shown in FIG. 10A. The size of interior baseboard 288 can be adjusted prior to installation to accommodate flooring finishes of different types. For this reason, the interior face 142 is provided with a first elongate linear notch 149 (see FIGS. 9B, 9C) above bottom edge 144 a sufficient distance to indicate the cut line for accommodating thin flooring, such as floor tiles, and a second elongate linear notch 139 (see FIGS. 9B, 9C), above notch 149 a sufficient distance to indicate the cut line for accommodating thicker flooring, such as hardwood flooring.

In use, the hook ledge 145 of interior baseboard 140 engages the bevel edge 297 of the toe screw housings 288 positioned along the bottom of the wall component 200, which thus facilitates the rapid and accurate placement of interior baseboard 140. The interior baseboard 140 can be secured in place by providing for example hook-and-loop fasteners, or adhesive material, in the fastening recess 138 of the interior baseboard 140. Toe screw housings 288 and interior baseboard 140 can be made from aluminum, plastics and the like. It is preferred to fabricate the toe screw housing 288 and interior baseboard 140 from foamed polyvinyl chloride (PVC), particularly Celuka foamed PVC.

### Floor Component (300)

Typically, structure 150 will utilize one floor component 300; thus floor component 300 generally is the full floor of structure 150.

### A. General Description

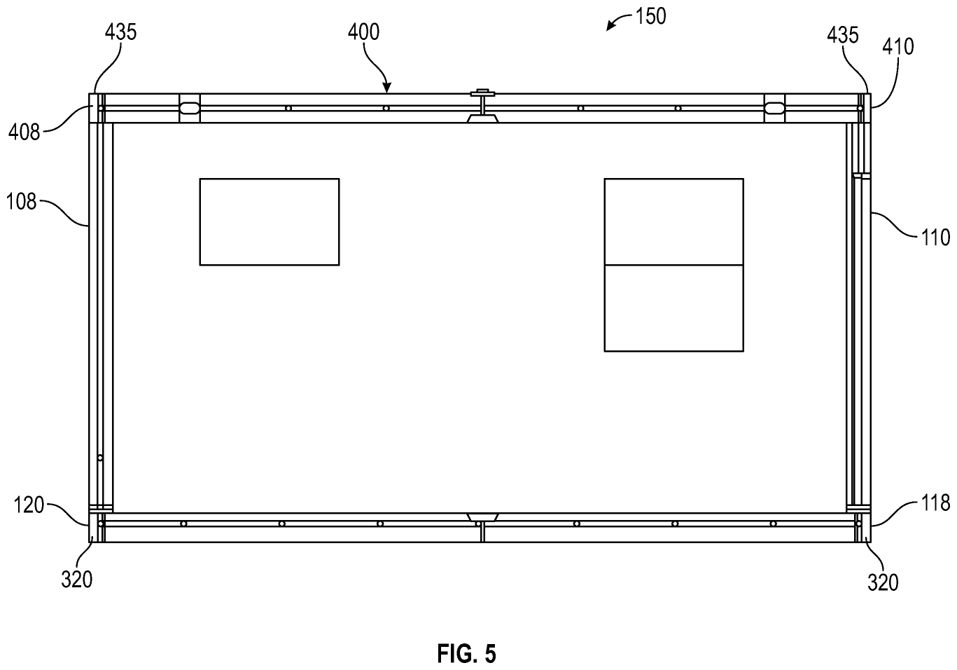

Floor component 300 has a generally rectangular perimeter. FIGS. 4 and 5 depict edge-on views of floor component 300 in accordance with the present inventions. The perimeter of floor component 300 is defined by first longitudinal floor edge 117, first transverse floor edge 120, second longitudinal floor edge 119 and second transverse floor edge 118. In particular, (a) first longitudinal floor edge 117, (b) first transverse floor edge 120, (c) second longitudinal floor edge 119 and (d) second transverse floor edge 118 generally coincide with (i.e., underlie) (w) first longitudinal edge 106, (x) first transverse edge 108, (y) second longitudinal edge 116 and (z) second transverse edge 110, respectively, of structure 150.

The length and width of floor component 300 can vary in accordance with design preference. In the particular embodiment of structure 150 depicted in FIGS. 2, 4 and 5, floor component 300 is approximately 19 feet (5.79 m) by 19 feet (5.79 m).

Floor component 300 and its constituent elements are generally designed and dimensioned in thickness and in other respects to accommodate the particular loads to which floor component 300 may be subject. It is preferred that floor component 300 utilize a multi-layered, laminate design, such as that described in connection with FIG. 7. In the embodiment shown in FIGS. 4 and 5, the bottom-most surface of floor component 300 comprises sheet metal layer 205 of first structural layer 210, with sheet metal layer 205 being 24 gauge galvanized steel approximately 0.022-0.028 inch thick. Above sheet metal layer 205 there are provided foam panels 214 of foam panel layer 213. In the embodiments shown in FIGS. 4 and 5, foam panels 214 are EPS foam for example approximately 7.125 inches thick.

Above foam panel layer 213 there is provided sheet metal layer 216 of second structural layer 215, with sheet metal layer 216 being 24 gauge galvanized steel approximately 0.022-0.028 inch thick. Above sheet metal layer 216 of second structural layer 215, there are provided building panels 219 of protective layer 218, with building panels 219 being MgO board approximately 0.25 inch (6 mm) thick.

The perimeter of each floor component 300 is generally provided with exterior edge reinforcement. As exterior edge reinforcement for the embodiments of floor component 300 shown in FIGS. 4 and 5, a first footing beam 320 (visible edge-on in FIG. 4) is positioned at the first longitudinal floor edge 117 of floor component 300, a second footing beam 320 (visible edge-on in FIG. 5) is positioned at the second transverse floor edge 118 of floor component 300, a third footing beam 320 (visible edge-on in FIG. 5) is positioned at the first transverse floor edge 120 of floor component 300, and a fourth footing beam 320 (visible edge-on in FIG. 4) is positioned at the second longitudinal floor edge 119 of floor component 300. In the case of floor component 300, the exterior edge reinforcement provided by footing beams 320 assists in resisting vertical loads and transferring such loads to any roof component 400 thereunder and then to underlying wall components 200, and/or to the foundation of the finished structure 150, in addition to protecting the edges of foam panel material. In the embodiment shown in FIGS. 1 through 6, the exterior edge reinforcement provided by footing beams 420 of floor component 300 is fabricated from laminated strand lumber board 7.125″ deep and 1.5″ thick.

### B. Floor Partitioning

The floor component 300 is partitioned into floor portion 300a and floor portion 300b. FIG. 2 shows flow portions 300a and 300b in plan view, and FIG. 4 shows floor portions 400a and 400b in section view, edge-on.

Each of the floor portions 300a and 300b is a planar generally rectangular structure, with floor portion 300a adjoining floor portion 300b. Interior edge 301a of floor portion 300a abuts interior edge 301b of floor portion 300b, as shown in FIG. 4. As interior edge reinforcement, a reinforcing board 307 is positioned in floor portion 300a adjacent interior edge 301a, and a reinforcing board is positioned in floor portion 300b adjacent interior edge 301b. In the embodiment show in in FIGS. 1 through 5, the interior edge reinforcement provided by reinforcing boards 307 is made of laminated strand lumber laminated strand lumber board

Referring to structure 150 shown in FIGS. 2 and 4, floor portion 300a is fixed in position relative to first wall portion 200s-1, third wall portion 200s-3 and wall component 200s-R. Floor portion 300a is joined with hinge structures to floor portion 300b, so as to permit floor portion 300b to pivot through approximately ninety degrees (90°) of arc about a horizontal axis 305, located proximate the top surface of floor component 300, between a fully folded position, where floor portion 300b is vertically oriented as shown in FIG. 3, and the fully unfolded position shown in FIGS. 2 and 4, where floor portion 300b is horizontally oriented and co-planar with floor portion 300a. Particular embodiments of structural members that incorporate hinge structures suitable to join floor portion 300a to floor portion 300b are described in in U.S. Nonprovisional patent application Ser. No. 17/527,520 entitled “Folding Beam Systems”, filed Nov. 16, 2021 and having the same inventors as this disclosure. The contents of that U.S. Nonprovisional patent application Ser. No. 17/527,520 entitled “Folding Beam Systems”, filed Nov. 16, 2021 and having the same inventors as this disclosure, is incorporated by reference as if fully set forth herein, particularly the description of the hinged load transfer components set forth for example in [symbol] 0074-0089 and in FIGS. 8A-13E thereof, as well as the description of the associated end hinge assemblies set forth for example in [symbol] 0090-0093 and in FIGS. 14A-14B thereof.

### Roof Component (400)

Typically, structure 150 will utilize one roof component 400; thus roof component 400 generally is the full roof of structure 150.

### A. General Description

Roof component 400 has a generally rectangular perimeter. FIGS. 1, 4 and 5 depict roof component 400 in accordance with the present inventions. The perimeter of roof component 400 is defined by first longitudinal roof edge 406, first transverse roof edge 408, second longitudinal roof edge 416 and second transverse roof edge 410. In particular, (a) first longitudinal roof edge 406, (b) first transverse roof edge 408, (c) second longitudinal roof edge 416 and (d) second transverse roof edge 410 of roof component 400 generally coincide with (i.e., overlie) (w) first longitudinal edge 106, (x) first transverse edge 108, (y) second longitudinal edge 116 and (z) second transverse edge 110, respectively, of structure 150.

The length and width of roof component 400 can vary in accordance with design preference. In the particular embodiment of structure 150 depicted in FIGS. 1, 4 and 5, the length and width of roof component 400 approximates the length and width of floor component 300.

Roof component 400 and its constituent elements are generally designed and dimensioned in thickness and in other respects to accommodate the particular loads to which roof component 400 may be subject. It is preferred that roof component 400 utilize a multi-layered, laminate design, such as that described in connection with FIG. 7. In the embodiment shown in FIGS. 4 and 5, the top-most surface of roof component 400 comprises sheet metal layer 205 of first structural layer 210, with sheet metal layer 205 being 24 gauge galvanized steel approximately 0.022-0.028 inch thick. Below sheet metal layer 205 there are provided foam panels 214 of foam panel layer 213, with foam panels 214 in the embodiment shown in FIGS. 4 and 5 being EPS foam for example approximately 7.125 inches thick. Below foam panel layer 213 there is provided sheet metal layer 216 of second structural layer 215, with sheet metal layer 216 being 24 gauge galvanized steel approximately 0.022-0.028 inch thick. Below sheet metal layer 216 of second structural layer 215, there are provided building panels 219 of protective layer 218, with building panels 219 being MgO board approximately 0.25 inch (6 mm) thick.

The perimeter of roof component 400 is generally provided with exterior edge reinforcement. As exterior edge reinforcement for the embodiment of roof component 400 shown in FIGS. 4 and 5, a first shoulder beam 435 (visible edge-on in FIG. 4) is positioned at the first longitudinal roof edge 406 of roof component 400, a second shoulder beam 435 (visible edge-on in FIG. 5) is positioned at the first transverse roof edge 408 of roof component 400, a third shoulder beam 435 (visible edge-on in FIG. 5) is positioned at the second transverse roof edge 410 of roof component 400, and a fourth shoulder beam 435 (visible edge-on in FIG. 4) is positioned at the second longitudinal roof edge 416 of roof component 400. In addition to protecting the exterior edges of foam panel material, the exterior edge reinforcement provided by shoulder beams 435 assists in resisting vertical loads and transferring such loads to lower floors through underlying wall components 200 supporting roof component 400, and then to the foundation of the structure 150. Such exterior edge reinforcement can also provide a region for fastening like regions of abutting enclosure components 155 (underlying and any overlying). Shoulder beams 435 of roof component 400 can be fabricated from laminated strand lumber board 7.125″ deep and 1.5″ thick.

### B. Roof Partitioning

The roof component 400 of structure 150 is partitioned into roof portions 400a, 400b and 400c. FIG. 1 shows roof portions 400a, 400b and 400c in perspective view, and FIG. 4 shows roof portions 400a, 400b and 400c in section view, edge-on.

Each of the roof portions 400a, 400b and 400c is a planar generally rectangular structure, with roof portion 400a adjoining roof portion 400b, and roof portion 400b adjoining roof portion 400c. Interior edge 412c of roof component 400c abuts a first interior edge 412b of roof component 400b, as shown in FIG. 4. For interior edge reinforcement, a reinforcing board 437 is positioned adjacent interior edge 412c, and a reinforcing board 437 is positioned against first interior edge 412b. Interior edge 412a of roof portion 400a abuts a second interior edge 412b of roof portion 400b, as shown in FIG. 4. For interior edge reinforcement, a reinforcing board 437 is positioned adjacent interior edge 412a, and a reinforcing board 437 is positioned against second interior edge 412b. In the embodiment shown in FIGS. 1 through 5, the interior edge reinforcement provided by reinforcing boards 437 of roof component 400 is laminated strand lumber board 7.125″ deep and 1.5″ thick.

In the shipping module 100 shown in FIG. 3, roof portions 400a, 400b and 400c preferably are accordion folded (stacked), with roof component 400b stacked on top of roof component 400a, and roof component 400c stacked on top of the roof component 400b. Referring to structure 150 shown in FIG. 4, roof portion 400a is fixed in position relative to first wall portion 200s-1, third wall portion 200s-3 and wall component 200R. Thus to realize the accordion folded configuration shown in FIG. 3 roof portion 400a is joined to roof portion 400b with hinge structures provided between interior edge 412a of roof portion 400a and second interior edge 412b of roof portion 400b. Such hinge structures are adapted to permit roof portion 400b to pivot through up to one hundred and eighty degrees (180°) of arc about a horizontal axis 405a, located proximate the top of roof component 400 and shown in FIG. 4, between the roof fully folded position shown in FIG. 3, where roof portion 400b lies stacked flat against roof portion 400a, and the fully unfolded position shown in FIG. 4. In turn, roof portion 400b is joined to roof portion 400c with hinge structures provided between first interior edge 412b of roof portion 400b and interior edge 412c of roof portion 400c. Such hinge structures are adapted to permit roof portion 400c to pivot through up to one hundred and eighty degrees (180°) of arc about a horizontal axis 405b, located proximate the bottom of roof component 400 and shown in FIG. 4, between the folded position shown in FIG. 3, where roof portion 400c lies stacked flat against roof portion 400b (when roof portion 400b is positioned to lie flat against roof portion 400a), and the fully unfolded position shown in FIG. 4.

Particular embodiments of structural members, which also incorporate hinge structures suitable for joining roof portion 400a to roof portion 400b, and for joining roof portion 400b to roof portion 400c, are described in in U.S. Nonprovisional patent application Ser. No. 17/527,520 entitled “Folding Beam Systems”, filed Nov. 16, 2021 and having the same inventors as this disclosure. The contents of that U.S. Nonprovisional patent application Ser. No. 17/527,520 entitled “Folding Beam Systems”, filed Nov. 16, 2021 and having the same inventors as this disclosure, is incorporated by reference as if fully set forth herein, particularly the description of the load transfer components set forth for example in [symbol] 0104-0126 and in FIGS. 15A-24A thereof, as well as the description of the associated end hinge assemblies set forth for example in [symbol] 0127-0132 and in FIGS. 24B and 25A-25D thereof.

### Enclosure Component Manufacture

For enclosure components 155 utilizing the multi-layered, laminate design disclosed herein in reference to FIG. 7, the metal sheets 206 and 217 that can be used to form first structural layer 210 and second structural layer 215 respectively can be entirely flat and juxtaposed in a simple abutting relationship. Optionally, metal sheets 206 and 217 can be provided with edge structures that facilitate placement of sheets and panels during manufacture.

Particular edge structure designs for metal sheets 206 and 217 are described in U.S. Nonprovisional patent application Ser. No. 17/504,883 entitled “Sheet/Panel Design for Enclosure Component Manufacture,” having the same inventors as the inventions described herein and filed on Oct. 19, 2021. The contents of U.S. Nonprovisional patent application Ser. No. 17/504,883 entitled “Sheet/Panel Design for Enclosure Component Manufacture,” having the same inventors as the inventions described herein and filed on Oct. 19, 2021, are incorporated by reference as if fully set forth herein, particularly including the exterior and interior edge structure designs described for example at [symbol] 00187-00205 and 00212 and in FIGS. 8, 9A-9C, 23A-23J and 24A-24B thereof.

A facility suitable for the manufacture of enclosure components 155, as well as exemplary manufacturing steps, are also described in U.S. Nonprovisional patent application Ser. No. 17/504,883 entitled “Sheet/Panel Design for Enclosure Component Manufacture,” having the same inventors as the inventions described herein and filed on Oct. 19, 2021. The contents of U.S. Nonprovisional patent application Ser. No. 17/504,883 entitled “Sheet/Panel Design for Enclosure Component Manufacture,” having the same inventors as the inventions described herein and filed on Oct. 19, 2021, are incorporated by reference as if fully set forth herein, particularly including the facility suitable for manufacturing the enclosure components 155 of the present invention, as well as exemplary manufacturing steps, described for example at [symbol] 00178-00186 and 00206-00222, and in FIGS. 22, 23A-23J and 24A-24B.

### Fixed Space Portion Build-Out and Finishing

Referring to FIGS. 2 and 10A-10C, structure 150 includes a fixed space portion 102 defined by roof component 400a (shown in FIG. 3), floor component 300a, wall component 200R, wall portion 200s-1 and wall portion 200s-3. (Fixed space portion 102 is also shown edge-on in the shipping module 100 depicted in FIG. 3). It is preferred that the fixed space portion 102 be fitted out during manufacture with internal components, such as kitchens, bathrooms, closets, storage areas, corridors, etc., so as to be in a relatively finished state prior to shipment of shipping module 100.

For example, interior partition walls as desired can be put into fixed space portion 102 during manufacture. Referring to FIGS. 2 and 10A-10C, there is shown a longitudinal partition wall 126 and a transverse partition wall 127. Partition walls 126 and 127 each can comprise a foam panel layer, for example three inches (3″) thick, with building panels such as magnesium oxide (MgO) board approximately 0.25 inch (6 mm) thick fastened to each face of the foam panel using a suitable adhesive, preferably a polyurethane based construction adhesive.

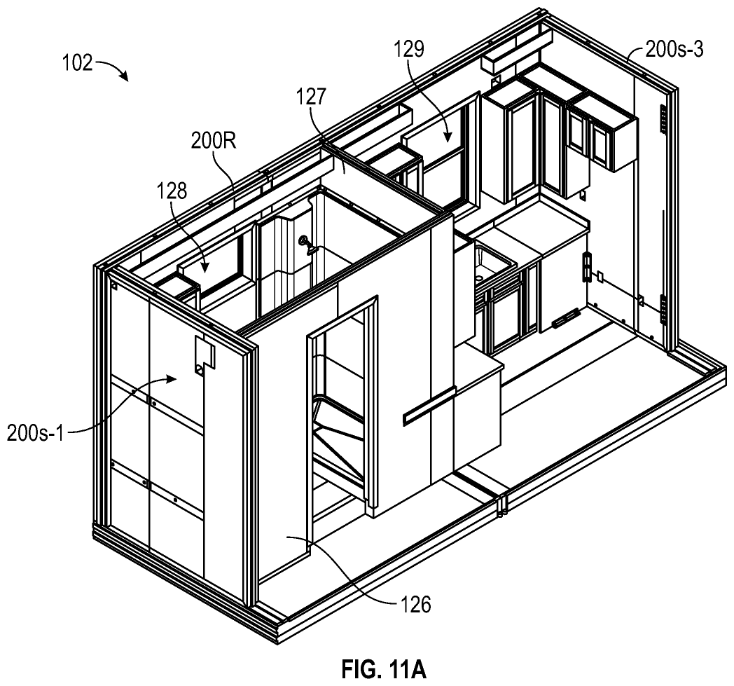

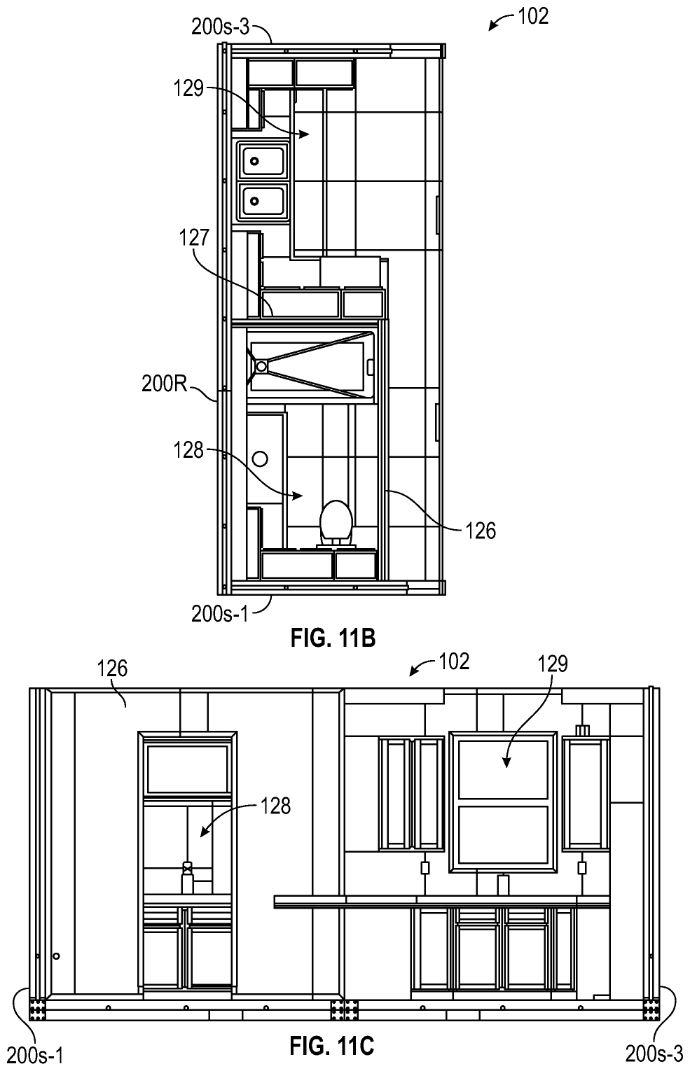

As shown for example in FIG. 11A, a first vertical edge of longitudinal partition wall 126 abuts wall portion 200s-1, and a first vertical edge of transverse partition wall 127 abuts wall component 200R. The second vertical edge of transverse wall portion 127 abuts the longitudinal partition wall 126 proximate to the latter's second vertical edge, such that partition walls 126 and 127, with wall component 200R and wall portion 200s-1, form a rectangular enclosed area that, in the embodiment shown in FIGS. 2 and 11A-11C, is a bath room 128. In the embodiment shown, bath room 128 is fitted out during manufacture to include a shower enclosure, a toilet and a wash sink.

The open area between transverse partition wall 127 and wall portion 200s-3 in the embodiment shown in FIGS. 2 and 11A-11C is a kitchen area 129. In the embodiment shown in FIGS. 11A-11C, kitchen area 129 is fitted out during manufacture to include cabinets, countertops and cooking facilities.

Also, in the embodiment shown in FIGS. 1 and 2, wall components 200 are fitted during manufacture and prior to shipment with all necessary door and window assemblies, with the enclosure components 155 being pre-wired for electrical needs.

Carrying out the foregoing steps prior to shipment permits the builder, in effect, to erect a largely finished structure simply by “unfolding” (deploying) the positioned components of shipping module 100.

### Enclosure Component Relationships and Assembly for Transport

It is preferred that there be a specific dimensional relationship among enclosure components 155.

FIG. 2 shows a top schematic view of structure 150 shown in FIG. 1, and includes a geometrical orthogonal grid for clarity of explaining the preferred dimensional relationships among its enclosure components 155. The basic length used for dimensioning is indicated as “E” in FIG. 2; the orthogonal grid overlaid in FIG. 2 is 8E long and 8E wide; notably, the entire structure 150 preferably is bounded by this 8E by 8E orthogonal grid.

Roof portions 400a, 400b and 400c each can be identically dimensioned in the transverse direction. Alternatively, referring to FIG. 3, roof portion 400c can be dimensioned to be larger than either of roof portion 400a and roof portion 400b in the transverse direction to reduce the chances of binding during the unfolding of roof portions 400b, 400c. Further specifics on dimensioning roof portion 400c in the foregoing manner are described in U.S. Nonprovisional application Ser. No. 17/569,962, entitled “Improved Folding Roof Component,” filed on Jan. 6, 2022. In addition, as described in U.S. Nonprovisional patent application Ser. No. 16/786,315, entitled “Equipment and Methods for Erecting a Transportable Foldable Building Structure,” filed on Feb. 10, 2020 and now U.S. Pat. No. 11,220,816, as well as in U.S. Nonprovisional application Ser. No. 17/569,962 mentioned above, friction-reducing components can be used to facilitate unfolding roof component 400, such as by positioning a first wheel caster at the leading edge of roof portion 400c proximate to the corner of roof portion 400c that is supported by wall portion 200s-2 as roof portion 400c is deployed, and by positioning a second similar wheel caster at the leading edge of roof portion 400c proximate to the corner of roof portion 400c that is supported by wall portion 200s-4 as roof portion 400c is deployed.

In FIG. 2, the four wall components 200 are each approximately 8E long, and each of roof portions 400a and 400b is approximately 8E long and 2.5E wide. Roof portion 400c is approximately 8E long and 2.9E wide. In FIGS. 2 and 3, each of floor components 300a and 300b is 8H long; whereas floor component 300a is just over 3E wide and floor component 300b is just under 5E wide.

As shown in FIG. 2, fourth wall portion 200s-4 is folded inward and positioned generally against fixed space portion 102, and second wall portion 200s-2 is folded inward and positioned generally against fourth wall portion 200s-4 (wall portions 200s-2 and 200s-4 are respectively identified in FIG. 2 as portions 200s-2f and 200s-4f when so folded and positioned). The three roof components 400a, 400b and 400c are shown unfolded in FIG. 1 and shown folded (stacked) in FIG. 3, with roof component 400b stacked on top of roof component 400a, and roof component 400c stacked on top of the roof component 400b. Wall component 200P, shown in FIGS. 2 and 3, is pivotally secured to floor portion 300b at the location of axis 105, and is vertically positioned against the outside of wall portions 200s-2 and 200s-4. In turn, floor portion 300b is vertically positioned proximate fixed space portion 102, with wall component 200P pending from floor portion 300b between floor portion 300b and wall portions 200s-2 and 200s-4.

Sizing the enclosure components 155 of structure 150 according to the dimensional relationships disclosed above yields a compact shipping module 100, as can be seen from the figures. Thus shipping module 100 depicted in FIG. 3, when dimensioned according to the relationships disclosed herein using an “E” dimension (see FIG. 2) of approximately 28.625 inches (72.7 cm), and when its components are stacked and positioned as shown in FIG. 3, has an overall length of approximately 19 feet (5.79 m), an overall width of approximately 8.5 feet (2.59 meters) and an overall height of approximately 12.7 feet (3.87 meters). These overall dimensions are less than a typical shipping container.

Each of the wall, floor and roof components 200, 300 and 400, and/or the portions thereof, can be sheathed in protective film 177 during fabrication and prior to forming the shipping module 100. Alternatively or in addition, the entire shipping module 100 can be sheathed in a protective film. Such protective films can remain in place until after the shipping module 100 is at the construction site, and then removed as required to facilitate enclosure component deployment and finishing.

### Shipping Module Transport

The shipping module 100 is shipped to the building site by appropriate transport means. One such transport means is disclosed in U.S. Nonprovisional application Ser. No. 16/143,628, filed Sep. 27, 2018 and now U.S. Pat. No. 11,007,921, issued May 18, 2021; the contents of that U.S. Nonprovisional application Ser. No. 16/143,628, filed Sep. 27, 2018 are incorporated by reference as if fully set forth herein, particularly as found at paragraphs 0020-0035 and in FIGS. 1A-2D thereof. As an alternative transport means, shipping module 100 can be shipped to the building site by means of a conventional truck trailer or a low bed trailer (also referred to as a lowboy trailer), and in the case of over-the-water shipments, by ship.

### Structure Deployment and Finishing

At the building site, shipping module 100 is positioned over its desired location, such as over a prepared foundation; for example, a poured concrete slab, a poured concrete or cinder block foundation, sleeper beams or concrete posts or columns. This can be accomplished by using a crane, either to lift shipping module 100 from its transport and move it to the desired location, or by positioning the transport means over the desired location, lifting shipping module 100, then moving the transport means from the desired location, and then lowering shipping module 100 to a rest state at the desired location. Particularly suitable equipment and techniques for facilitating the positioning of a shipping module 100 at the desired location are disclosed in U.S. Nonprovisional patent application Ser. No. 16/786,315, entitled “Equipment and Methods for Erecting a Transportable Foldable Building Structure,” and filed on Feb. 10, 2020, now U.S. Pat. No. 11,220,816. The contents of that U.S. Nonprovisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at [symbol] 126-128 and in connection with FIGS. 11A and 11B thereof.

Following positioning of shipping module 100 at the building site, the appropriate portions of wall, floor and roof components 200, 300 and 400 are “unfolded” (i.e., deployed) to yield structure 150. Unfolding occurs in the following sequence: (1) floor portion 300b is pivotally rotated about horizontal axis 305 (shown in FIGS. 3 and 4) to an unfolded position, (2) wall component 200P is pivotally rotated about horizontal axis 105 (the general location of which is shown in FIG. 3) to an unfolded position, (3) wall portions 200s-2 and 200s-4 are pivotally rotated about vertical axes 192 and 194 (shown in FIG. 2) respectively to unfolded positions, and (4) roof portions 400b and 400c are pivotally rotated about horizontal axes 405a and 405b (shown in FIGS. 3 and 4) respectively to unfolded positions.

A mobile crane can be used to assist in the deployment of certain of the enclosure components 155, specifically roof portions 400b and 400c, floor portion 300b, as well as the wall component 200P pivotally secured to floor portion 300b. Alternatively, particularly suitable equipment and techniques for facilitating the deployment of enclosure components 155 are disclosed in U.S. Nonprovisional patent application Ser. No. 16/786,315, entitled “Equipment and Methods for Erecting a Transportable Foldable Building Structure,” and filed on Feb. 10, 2020, now U.S. Pat. No. 11,220,816. The contents of that U.S. Nonprovisional patent application Ser. No. 16/786,315, entitled “Equipment and Methods for Erecting a Transportable Foldable Building Structure,” and filed on Feb. 10, 2020, are incorporated by reference as if fully set forth herein, particularly including the equipment and techniques described for example at [symbol] 132-145 and depicted in FIGS. 12A-14B thereof.

After unfolding, the enclosure components 155 are secured together to finish the structure 150 that is shown in FIG. 1. If any temporary hinge structures have been utilized, then these temporary hinge structures can be removed if desired and the enclosure components 155 can be secured together. During or after unfolding and securing of the enclosure components 155, any remaining finishing operations are performed, such as addition of roofing material, and making hook-ups to electrical, fresh water and sewer lines to complete structure 150, as relevant here.

This disclosure should be understood to include (as illustrative and not limiting) the subject matter set forth in the following numbered clauses:

Clause 1. A toe screw housing for securing abutting enclosure components together, comprising:

a bearing plate with a planar interior face, a planar exterior face and a beveled upper edge beveled at a non-perpendicular first angle relative to the exterior face;

a toe screw well joined to and extending away from the interior face and including a fastener shelf;

a toe screw support joined to the interior face, and joined to and extending away from the fastener shelf, the toe screw support distal from the fastener shelf including a planar support surface oriented perpendicular to the interior face; and

a fastener bore passing through the fastener shelf, the toe screw support and the support surface and inclined at a non-perpendicular second angle relative to the interior face of the bearing plate.

Clause 2. The toe screw housing of clause 1, further including a groove formed in the support surface oriented parallel to the interior face.

Clause 3. The toe screw housing of either of clause 1 or clause 2, wherein the second angle is in the range of forty-five degrees (45°) to seventy degrees (70°).

Clause 4. The toe screw housing of any one of clause 1, 2 or 3, where the second angle is sixty degrees (60°).

Clause 5. The toe screw housing of any one of clause 1, 2, 3 or 4, where the first angle is less than forty-five degree (45°).

Clause 6. The toe screw housing of any one of clause 1, 2, 3, 4 or 5, where the first angle is twenty degrees (20°).

Clause 7. A baseboard for masking a toe screw bearing plate having a beveled upper edge, comprising:

a planar elongate member having an elongate interior face, an elongate top edge and an elongate bottom edge;

an elongate hook ledge joined to the top edge of the base board forming a wedge-shaped angled slot that is oriented to be open in the direction of the bottom edge, the wedge-shaped angled slot configured to be positioned over the beveled upper edge of the bearing plate;

an elongate linear first step positioned on the interior face below the angled slot to form an elongate first recess on the interior face configured to receive the toe screw bearing plate; and

an elongate second step positioned on the interior face below the elongate first step to form an elongate second recess on the interior face.

Clause 8. A baseboard as in clause 7, further comprising a first elongate linear notch in the second step a first select distance above the bottom edge.

Clause 9. A baseboard as in either of clause 7 or clause 8, further comprising a second elongate linear notch in the second step a second select distance above the bottom edge that is greater than the first select distance.

Clause 10. A system for securing abutting enclosure components together, comprising:

(a) a toe screw housing that includes:

(i) a bearing plate with a planar interior face, a planar exterior face and a beveled upper edge beveled at a non-perpendicular first angle relative to the exterior face;

(ii) a toe screw well joined to and extending away from the interior face and including a fastener shelf;

(iii) a toe screw support joined to the interior face, and joined to and extending away from the fastener shelf, the toe screw support distal from the fastener shelf including a planar support surface oriented perpendicular to the interior face; and

(iv) a fastener bore passing through the fastener shelf, the toe screw support and the support surface and inclined at a non-perpendicular second angle relative to the interior face of the bearing plate; and

(b) a planar elongate base board having an elongate top edge and an elongate bottom edge and including;

(i) an elongate hook ledge joined to the top edge of the base board, the hook ledge positioned over the beveled upper edge of the bearing plate; and

(ii) an elongate linear first step positioned on the interior face below the angled slot to form an elongate first recess on the interior face in which is positioned the toe screw bearing plate.

Clause 11. The system of claim 10, further comprising (iii) an elongate second step positioned on the interior face of the base board below the elongate first step to form an elongate second recess on the interior face.

Clause 12. A wall component comprising:

(a) a foam panel layer having a first face and an opposing second face;

(b) a metal sheet layer having a first face, an opposing second face, with the first face of the metal sheet layer being bonded to the opposing second face of the foam panel layer; and

(c) a protective layer having a first face, an opposing second face, with the first face of the protective layer being bonded to the opposing second face of the sheet metal layer;

(d) an elongate external edge reinforcement abutting the foam panel layer;

(e) a plurality of toe screw housings, each of the plurality of toe screw housings comprising:

(i) a bearing plate with a planar interior face, a planar exterior face and a beveled upper edge beveled at a non-perpendicular first angle relative to the exterior face;

(ii) a toe screw well joined to and extending away from the interior face and including a fastener shelf;

(iii) a toe screw support joined to the interior face, and joined to and extending away from the fastener shelf, the toe screw support distal from the fastener shelf including a planar support surface oriented perpendicular to the interior face; and

(iv) a fastener bore passing through the fastener shelf, the toe screw support and the support surface and inclined at a non-perpendicular second angle relative to the interior face of the bearing plate; and

(f) the toe screw well and toe screw support of each toe screw housing positioned in a respective one of a plurality of spaced-apart apertures passing through the protective layer and the metal sheet layer, and in a respective one of a plurality of corresponding cavities formed in the foam panel layer, with the planar support surface of the toe screw support of each of the plurality of toe screw housings positioned against the external edge reinforcement and with the interior face of the bearing plate positioned against the protective layer

Clause 13. A folded building structure transportable to a site at which the folded building structure is to be erected, comprising:

a fixed space portion defined by (i) a first floor portion having an edge reinforcement along a first outside edge and an edge reinforcement segment along an adjacent second outside edge, (ii) a first wall component having an edge reinforcement along a first bottom edge positioned on the first floor portion proximate the first outside edge, and (iii) a planar fixed wall portion of a second wall component having an edge reinforcement segment along a second bottom edge positioned on the first floor portion proximate the second outside edge;

a second floor portion vertically positioned in a second floor portion folded position opposite to the first wall component and pivotally connected to the first floor portion to permit the second floor portion to pivot, about a first horizontal axis relative to the first floor portion, from the second floor portion folded position to a second floor portion unfolded position, the second floor portion having an edge reinforcement along a third outside edge distal from the first horizontal axis and an edge reinforcement segment along an adjacent fourth outside edge;

a third wall component vertically positioned in a third wall component folded position against the second floor portion, the third wall component pivotally connected to the second floor portion to permit the third wall portion to pivot, about a second horizontal axis relative to the second floor portion, from the third wall component folded position to a third wall component unfolded position, the third wall component having an edge reinforcement along a third bottom edge positioned on the second floor portion proximate to the third outside edge when the second floor portion is in the second floor portion unfolded position and the third wall component is in the third wall component unfolded position;

the second wall component additionally including a planar pivoting wall portion having an edge reinforcement segment along a fourth bottom edge, the pivoting wall portion (i) disposed in a pivoting portion folded position proximate the fixed space portion, and (ii) pivotally connected to the fixed wall portion of the second wall component to permit the pivoting wall portion to pivot, about a vertical axis relative to the fixed wall portion of the second wall component, from the pivoting portion folded position to a pivoting portion unfolded position in which at least a portion of the fourth bottom edge is positioned on the second floor portion proximate to the fourth outside edge when the second floor portion is in the second floor portion unfolded position and the pivoting wall portion is in the pivoting portion unfolded position;

a first plurality of toe screw housings having a spaced-apart relationship, each of the first plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and

the toe screw well and toe screw support of at least a first of the first plurality of toe screw housings positioned with the interior face of its bearing plate against an inside surface of the pivoting wall portion and with its support surface against the edge reinforcement segment along the fourth bottom edge of the pivoting wall portion.

Clause 14. A folded building structure as in clause 13, further comprising a second plurality of toe screw housings having a spaced-apart relationship, each of the second plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and the toe screw well and toe screw support of each of the second plurality of toe screw housings positioned with the interior face of its bearing plate against an inside surface of the third wall component and with its support surface against the edge reinforcement along the third bottom edge of the third wall component.

Clause 15. A folded building structure as in either of clause 13 or clause 14, further comprising a third plurality of toe screw housings having a spaced-apart relationship, each of the third plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate;

the toe screw well and toe screw support of each of the third plurality of toe screw housings positioned with the interior face of its bearing plate against an inside surface of the first wall component and with its support surface against the edge reinforcement along the first bottom edge of the first wall component; and

a first fastener positioned within at least one of the third plurality of toe screw housings, the first fastener comprising a head in pressing contact with the fastener shelf thereof, and a shank passing through the toe screw well thereof, through the edge reinforcement along the first bottom edge of the first wall component and into the edge reinforcement along the first outside edge of the first floor portion.

Clause 16. A folded building structure as in any one of clause 13. 14 or 15, further comprising a fourth plurality of toe screw housings having a spaced-apart relationship, each of the fourth plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate;

the toe screw well and toe screw support of each of the fourth plurality of toe screw housings positioned with the interior face of its bearing plate against an inside surface of the fixed wall portion and with its support surface against the edge reinforcement segment along the second bottom edge of the fixed wall portion; and

a second fastener positioned within at least one of the fourth plurality of toe screw housings, the second fastener comprising a head in pressing contact with the fastener shelf thereof, and a shank passing through the toe screw well thereof, through the edge reinforcement segment along the second bottom edge of the fixed wall portion and into the edge reinforcement segment along the second outside edge of the first floor portion.

Clause 17. A building comprising:

an interior region defined by (i) a floor portion having an edge reinforcement along a first outside edge and an edge reinforcement segment along an adjacent second outside edge, (ii) a wall component having an edge reinforcement along a first bottom edge positioned on the first floor portion proximate the first outside edge, and (iii) a wall portion having an edge reinforcement segment along a second bottom edge positioned on the first floor portion proximate the second outside edge;

a first plurality of toe screw housings having a spaced-apart relationship, each of the first plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and

the toe screw well and toe screw support of each of the first plurality of toe screw housings positioned with the interior face of its bearing plate against an inside surface of the wall component and with its support surface against the edge reinforcement along the first bottom edge of the wall component.

Clause 18. The building of clause 17, further comprising a first interior partition wall abutting one of (i) the inside surface of the wall component and (ii) an inside surface of the wall portion, and extending perpendicularly therefrom.

Clause 19. The building of clause 18, further comprising a second interior partition wall abutting the other of the inside surface of the wall component and the inside surface of the wall portion and extending perpendicularly therefrom to form a junction with the first interior partition wall and thereby define an enclosed interior space.

Clause 20. The building of either of clause 18 or clause 19, wherein the first interior partition wall comprises:

(a) a foam panel layer having a first face and an opposing second face;

(b) a first protective layer having a first face, an opposing second face, with the first face of the first protective layer being bonded to the first face of the foam panel layer; and

(c) a second protective layer having a first face, an opposing second face, with the first face of the second protective layer being bonded to the opposing second face of the foam panel layer.

Clause 21. The building of clause 19, wherein the second interior partition wall comprises:

(a) a foam panel layer having a first face and an opposing second face;

(b) a first protective layer having a first face, an opposing second face, with the first face of the first protective layer being bonded to the first face of the foam panel layer; and

(c) a second protective layer having a first face, an opposing second face, with the first face of the second protective layer being bonded to the opposing second face of the foam panel layer.

Clause 22. The building of either of clause 19 or clause 21, wherein the enclosed interior space includes one or more of a shower enclosure, a toilet and a wash sink.

Clause 23. The building of any one of clause 19, 21 or 22, wherein a portion of the interior region outside the enclosed interior space includes one or more of a cabinet, a countertop and a cooking facility.

Clause 24. The building of any one of clauses 17-23, wherein the first wall component comprises:

(a) a foam panel layer having a first face and an opposing second face;

(b) a metal sheet layer having a first face, an opposing second face, with the first face of the metal sheet layer being bonded to the opposing second face of the foam panel layer; and

(c) a protective layer having a first face, an opposing second face that constitutes the inside surface of the first wall component, with the first face of the protective layer being bonded to the opposing second face of the sheet metal layer; and

(d) the edge reinforcement along the first bottom edge of the first wall component abuts the foam panel layer.

Clause 25. The folded building structure of clause 15, further comprising a planar elongate base board having an elongate top edge and an elongate bottom edge, with an elongate hook ledge joined to the top edge of the base board and positioned over the beveled upper edge of the bearing plate of at least one of the toe screw housings of the third plurality of toe screw housings.

Clause 26. The folded building structure of clause 16, further comprising a planar elongate base board having an elongate top edge and an elongate bottom edge, with an elongate hook ledge joined to the top edge of the base board and positioned over the beveled upper edge of the bearing plate of at least one of the toe screw housings of the fourth plurality of toe screw housings.

The foregoing detailed description is for illustration only and is not to be deemed as limiting the inventions disclosed herein, which are defined in the appended claims.

What is claimed is:

1. A toe screw housing for securing abutting enclosure components together, comprising:
a bearing plate with a planar interior face, a planar exterior face and a beveled upper edge beveled at a non-perpendicular first angle relative to the exterior face;
a toe screw well joined to and extending away from the interior face and including a fastener shelf;
a toe screw support joined to the interior face, and joined to and extending away from the fastener shelf, the toe screw support distal from the fastener shelf including a planar support surface oriented perpendicular to the interior face; and
a fastener bore passing through the fastener shelf, the toe screw support and the support surface and inclined at a non-perpendicular second angle relative to the interior face of the bearing plate.

2. The toe screw housing of claim 1, further including a groove formed in the support surface oriented parallel to the interior face.

3. The toe screw housing of claim 1, wherein the second angle is in the range of forty-five degrees (45°) to seventy degrees (70°).

4. The toe screw housing of claim 3, where the second angle is sixty degrees (60°).

5. The toe screw housing of claim 1, where the first angle is less than forty-five degrees (45°).

6. The toe screw housing of claim 5, where the first angle is twenty degrees (20°).

7. A baseboard for masking a toe screw bearing plate having a beveled upper edge, comprising:
a planar elongate member having an elongate interior face, an elongate top edge and an elongate bottom edge;
an elongate hook ledge joined to the top edge of the base board forming a wedge-shaped angled slot that is oriented to be open in the direction of the bottom edge, the wedge-shaped angled slot configured to be positioned over the beveled upper edge of the bearing plate;
an elongate linear first step positioned on the interior face below the angled slot to form an elongate first recess on the interior face configured to receive the toe screw bearing plate; and
an elongate second step positioned on the interior face below the elongate first step to form an elongate second recess on the interior face.

8. A baseboard as in claim 7, further comprising a first elongate linear notch in the second step a first select distance above the bottom edge.

9. A baseboard as in claim 8, further comprising a second elongate linear notch in the second step a second select distance above the bottom edge that is greater than the first select distance.

10. A system for securing abutting enclosure components together, comprising:
(a) a toe screw housing that includes:
(i) a bearing plate with a planar interior face, a planar exterior face and a beveled upper edge beveled at a non-perpendicular first angle relative to the exterior face;
(ii) a toe screw well joined to and extending away from the interior face and including a fastener shelf;
(iii) a toe screw support joined to the interior face, and joined to and extending away from the fastener shelf, the toe screw support distal from the fastener shelf including a planar support surface oriented perpendicular to the interior face; and
(iv) a fastener bore passing through the fastener shelf, the toe screw support and the support surface and inclined at a non-perpendicular second angle relative to the interior face of the bearing plate; and
(b) a planar elongate base board having an elongate top edge and an elongate bottom edge and including;
(i) an elongate hook ledge joined to the top edge of the base board, the hook ledge positioned over the beveled upper edge of the bearing plate; and
(ii) an elongate linear first step positioned on the interior face below the angled slot to form an elongate first recess on the interior face in which is positioned the toe screw bearing plate.

11. The system of claim 10, further comprising (iii) an elongate second step positioned on the interior face of the base board below the elongate first step to form an elongate second recess on the interior face.

12. A wall component comprising:
(a) a foam panel layer having a first face and an opposing second face;
(b) a metal sheet layer having a first face, an opposing second face, with the first face of the metal sheet layer being bonded to the opposing second face of the foam panel layer; and
(c) a protective layer having a first face, an opposing second face, with the first face of the protective layer being bonded to the opposing second face of the sheet metal layer;
(d) an elongate external edge reinforcement abutting the foam panel layer;
(e) a plurality of toe screw housings, each of the plurality of toe screw housings comprising:
(i) a bearing plate with a planar interior face, a planar exterior face and a beveled upper edge beveled at a non-perpendicular first angle relative to the exterior face;
(ii) a toe screw well joined to and extending away from the interior face and including a fastener shelf;
(iii) a toe screw support joined to the interior face, and joined to and extending away from the fastener shelf, the toe screw support distal from the fastener shelf including a planar support surface oriented perpendicular to the interior face; and
(iv) a fastener bore passing through the fastener shelf, the toe screw support and the support surface and inclined at a non-perpendicular second angle relative to the interior face of the bearing plate; and
(f) the toe screw well and toe screw support of each toe screw housing positioned in a respective one of a plurality of spaced-apart apertures passing through the protective layer and the metal sheet layer, and in a respective one of a plurality of corresponding cavities formed in the foam panel layer, with the planar support surface of the toe screw support of each of the plurality of toe screw housings positioned against the external edge reinforcement and with the interior face of the bearing plate positioned against the protective layer.

13. A folded building structure transportable to a site at which the folded building structure is to be erected, comprising:
a fixed space portion defined by (i) a first floor portion having an edge reinforcement along a first outside edge and an edge reinforcement segment along an adjacent second outside edge, (ii) a first wall component having an edge reinforcement along a first bottom edge positioned on the first floor portion proximate the first outside edge, and (iii) a planar fixed wall portion of a second wall component having an edge reinforcement segment along a second bottom edge positioned on the first floor portion proximate the second outside edge;
a second floor portion vertically positioned in a second floor portion folded position opposite to the first wall component and pivotally connected to the first floor portion to permit the second floor portion to pivot, about a first horizontal axis relative to the first floor portion, from the second floor portion folded position to a second floor portion unfolded position, the second floor portion having an edge reinforcement along a third outside edge distal from the first horizontal axis and an edge reinforcement segment along an adjacent fourth outside edge;
a third wall component vertically positioned in a third wall component folded position against the second floor portion, the third wall component pivotally connected to the second floor portion to permit the third wall portion to pivot, about a second horizontal axis relative to the second floor portion, from the third wall component folded position to a third wall component unfolded position, the third wall component having an edge reinforcement along a third bottom edge positioned on the second floor portion proximate to the third outside edge when the second floor portion is in the second floor portion unfolded position and the third wall component is in the third wall component unfolded position;
the second wall component additionally including a planar pivoting wall portion having an edge reinforcement segment along a fourth bottom edge, the pivoting wall portion (i) disposed in a pivoting portion folded position proximate the fixed space portion, and (ii) pivotally connected to the fixed wall portion of the second wall component to permit the pivoting wall portion to pivot, about a vertical axis relative to the fixed wall portion of the second wall component, from the pivoting portion folded position to a pivoting portion unfolded position in which at least a portion of the fourth bottom edge is positioned on the second floor portion proximate to the fourth outside edge when the second floor portion is in the second floor portion unfolded position and the pivoting wall portion is in the pivoting portion unfolded position;
a first plurality of toe screw housings having a spaced-apart relationship, each of the first plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and
the toe screw well and toe screw support of at least a first of the first plurality of toe screw housings positioned with the interior face of its bearing plate against an inside surface of the pivoting wall portion and with its support surface against the edge reinforcement segment along the fourth bottom edge of the pivoting wall portion.

14. A folded building structure as in claim 13, further comprising a second plurality of toe screw housings having a spaced-apart relationship, each of the second plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and
the toe screw well and toe screw support of each of the second plurality of toe screw housings positioned with the interior face of its bearing plate against an inside surface of the third wall component and with its support surface against the edge reinforcement along the third bottom edge of the third wall component.

15. A folded building structure as in claim 14, further comprising a third plurality of toe screw housings having a spaced-apart relationship, each of the third plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate;
the toe screw well and toe screw support of each of the third plurality of toe screw housings positioned with the interior face of its bearing plate against an inside surface of the first wall component and with its support surface against the edge reinforcement along the first bottom edge of the first wall component; and
a first fastener positioned within at least one of the third plurality of toe screw housings, the first fastener comprising a head in pressing contact with the fastener shelf thereof, and a shank passing through the toe screw well thereof, through the edge reinforcement along the first bottom edge of the first wall component and into the edge reinforcement along the first outside edge of the first floor portion.

16. A folded building structure as in claim 15, further comprising a fourth plurality of toe screw housings having a spaced-apart relationship, each of the fourth plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate;
the toe screw well and toe screw support of each of the fourth plurality of toe screw housings positioned with the interior face of its bearing plate against an inside surface of the fixed wall portion and with its support surface against the edge reinforcement segment along the second bottom edge of the fixed wall portion; and
a second fastener positioned within at least one of the fourth plurality of toe screw housings, the second fastener comprising a head in pressing contact with the fastener shelf thereof, and a shank passing through the toe screw well thereof, through the edge reinforcement segment along the second bottom edge of the fixed wall portion and into the edge reinforcement segment along the second outside edge of the first floor portion.

17. A building comprising:
an interior region defined by (i) a floor portion having an edge reinforcement along a first outside edge and an edge reinforcement segment along an adjacent second outside edge, (ii) a wall component having an edge reinforcement along a first bottom edge positioned on the first floor portion proximate the first outside edge, and (iii) a wall portion having an edge reinforcement segment along a second bottom edge positioned on the first floor portion proximate the second outside edge;
a first plurality of toe screw housings having a spaced-apart relationship, each of the first plurality of toe screw housings comprising: (i) a bearing plate with a planar interior face, a planar exterior face and a beveled upper edge beveled at a non-perpendicular first angle relative to the exterior face, (ii) a toe screw well joined to and extending away from the interior face and including a fastener shelf, (iii) a toe screw support joined to the interior face, and joined to and extending away from the fastener shelf, the toe screw support distal from the fastener shelf including a planar support surface oriented perpendicular to the interior face, and (iv) a fastener bore passing through the fastener shelf, the toe screw support and the support surface and inclined at a non-perpendicular second angle relative to the interior face of the bearing plate; and
the toe screw well and toe screw support of each of the first plurality of toe screw housings positioned with the interior face of its bearing plate against an inside surface of the wall component and with its support surface against the edge reinforcement along the first bottom edge of the wall component.

18. The building of claim 17, further comprising a first interior partition wall abutting one of (i) the inside surface of the wall component and (ii) an inside surface of the wall portion, and extending perpendicularly therefrom.

19. The building of claim 18, further comprising a second interior partition wall abutting the other of the inside surface of the wall component and the inside surface of the wall portion and extending perpendicularly therefrom to form a junction with the first interior partition wall and thereby define an enclosed interior space.

20. The building of claim 18, wherein the first interior partition wall comprises:
(a) a foam panel layer having a first face and an opposing second face;
(b) a first protective layer having a first face, an opposing second face, with the first face of the first protective layer being bonded to the first face of the foam panel layer; and
(c) a second protective layer having a first face, an opposing second face, with the first face of the second protective layer being bonded to the opposing second face of the foam panel layer.

21. The building of claim 19, wherein the second interior partition wall comprises:
(a) a foam panel layer having a first face and an opposing second face;
(b) a first protective layer having a first face, an opposing second face, with the first face of the first protective layer being bonded to the first face of the foam panel layer; and
(c) a second protective layer having a first face, an opposing second face, with the first face of the second protective layer being bonded to the opposing second face of the foam panel layer.

22. The building of claim 19, wherein the enclosed interior space comprises one or more of a shower enclosure, a toilet and a wash sink.

23. The building of claim 22, wherein a portion of the interior region outside the enclosed interior space includes one or more of a cabinet, a countertop and a cooking facility.

24. The building of claim 23, wherein the first wall component comprises:
(a) a foam panel layer having a first face and an opposing second face;
(b) a metal sheet layer having a first face, an opposing second face, with the first face of the metal sheet layer being bonded to the opposing second face of the foam panel layer; and
(c) a protective layer having a first face, an opposing second face that constitutes the inside surface of the first wall component, with the first face of the protective layer being bonded to the opposing second face of the sheet metal layer; and
(d) the edge reinforcement along the first bottom edge of the first wall component abuts the foam panel layer.

25. The folded building structure of claim 15, further comprising a planar elongate base board having an elongate top edge and an elongate bottom edge, with an elongate hook ledge joined to the top edge of the base board and positioned over the beveled upper edge of the bearing plate of at least one of the toe screw housings of the third plurality of toe screw housings.

26. The folded building structure of claim 16, further comprising a planar elongate base board having an elongate top edge and an elongate bottom edge, with an elongate hook ledge joined to the top edge of the base board and positioned over the beveled upper edge of the bearing plate of at least one of the toe screw housings of the fourth plurality of toe screw housings.
